(19) United States
(12) Patent Application Publication
(10) Pub. No.: US 2023/0333530 A1
(43) Pub. Date: Oct. 19, 2023

(54) SYSTEM AND METHOD FOR EFFICIENTLY GENERATING HYDROGEN USING MULTIPLE AVAILABLE POWER SOURCES

(71) Applicant: Ohmium International, Inc., Incline Village, NV (US)

(72) Inventor: Chockkalingam Karuppaiah, Incline Village, NV (US)

(21) Appl. No.: 18/136,083

(22) Filed: Apr. 18, 2023

Related U.S. Application Data
(60) Provisional application No. 63/332,160, filed on Apr. 18, 2022.

(51) Int. Cl. G05B 19/042

(52) U.S. Cl. CPC G05B 19/042; G05B 2219/2639

(57) ABSTRACT

A system for generating hydrogen includes one or more processors operatively connected a hydrogen generator capable of being powered by a plurality of different power sources and a non-transitory computer-readable medium storing instructions that, when executed by the one or more processors, cause the one or more processors to: receive a first request to generate a first quantity of hydrogen; select a first one or more power sources of the plurality of different power sources to minimize a cost of generating the first quantity of hydrogen; connect the hydrogen generator to receive power from the first one or more power sources; and instruct the hydrogen generator to generate the first quantity of hydrogen using the first one or more power sources.

### CROSS-REFERENCE TO RELATED APPLICATIONS

This application claims the benefit of U.S. Provisional Application No. 63/332,160, filed Apr. 18, 2022, for “SYSTEM FOR INPUT FOLLOWING,” which is incorporated herein by reference in its entirety.

### TECHNICAL FIELD

The present disclosure is generally related to hydrogen generation and, more particularly, to a system and method for efficiently generating hydrogen using multiple available power sources.

### BACKGROUND

Currently, an issue with hydrogen generation systems is that they cannot change their inputted power sources. In addition, hydrogen generation systems do not consider the relative costs of multiple power sources that can be potentially used. For example, hydrogen generation systems do not determine which power sources would be the lowest cost option and adjust their usage accordingly.

### SUMMARY

In one aspect, a system for generating hydrogen includes one or more processors operatively connected a hydrogen generator capable of being powered by a plurality of different power sources. The system also includes a non-transitory computer-readable medium storing instructions that, when executed by the one or more processors, cause the one or more processors to: receive a first request to generate a first quantity of hydrogen; select a first one or more power sources of the plurality of different power sources to minimize a cost of generating the first quantity of hydrogen; connect the hydrogen generator to receive power from the first one or more power sources; and instruct the hydrogen generator to generate the first quantity of hydrogen using the first one or more power sources.

In some aspects, the first one or more power sources include at least one renewable power source, and the instructions further cause the one or more processors to disconnect the hydrogen generator from any non-renewable power sources and instruct the hydrogen generator to generate additional hydrogen to fill at least one storage tank using the at least one renewable power source. The at least one renewable power source may be solar, wind, geothermal, and/or hydropower.

In other aspects, the instructions further cause the one or more processors to store historical data relating to the cost of generating the first quantity of hydrogen. The historical data may include, without limitation, an indication of the first quantity of hydrogen, one or more of a date and time during which the first quantity of hydrogen is generated, price data for one or more of the plurality of different power sources, and/or weather data for a period of time during which the first quantity of hydrogen is generated. In some aspects, the weather data is selected from the group consisting of a UV index, a level of cloud cover, and a wind speed.

In still other aspects, storing the historical data relating to the cost of generating the first quantity of hydrogen includes training a machine learning system with the historical data. In one aspect, the machine learning system includes a neural network, and the instructions further cause the one or more processors to receive a second request to generate a second quantity of hydrogen and use the trained machine learning system to optimize selection a second one or more power sources of the plurality of different power sources to minimize a cost of generating the second quantity of hydrogen. In an aspect, using the trained machine learning system includes providing as input to the machine learning system at least one of an indication of the second quantity of hydrogen, price data for one or more of the plurality of different power sources, one or more of a date and time of the second request, and a weather forecast.

In another aspect, a computer-implemented method for generating hydrogen includes: receiving a first request to generate a first quantity of hydrogen using a hydrogen generator capable of being powered by a plurality of different power sources; selecting a first one or more power sources of the plurality of different power sources to minimize a cost of generating the first quantity of hydrogen; connecting the hydrogen generator to receive power from the first one or more power sources; and instructing the hydrogen generator to generate the first quantity of hydrogen using the first one or more power sources.

In yet another aspect, a non-transitory computer-readable medium stores program code that, when executed by one or more processors, causes the one or more processors to perform a method for generating hydrogen comprising: receiving a first request to generate a first quantity of hydrogen using a hydrogen generator capable of being powered by a plurality of different power sources; selecting a first one or more power sources of the plurality of different power sources to minimize a cost of generating the first quantity of hydrogen; connecting the hydrogen generator to receive power from the first one or more power sources; and instructing the hydrogen generator to generate the first quantity of hydrogen using the first one or more power sources.

### BRIEF DESCRIPTION OF THE DRAWINGS

The accompanying drawings illustrate embodiments and/or aspects of the disclosure and, together with the written description, serve to explain the principles of the disclosure. Wherever possible, the same reference numbers are used throughout the drawings to refer to the same or like elements of an embodiment. Non-limiting and non-exhaustive descriptions are described with reference to the following drawings. The components in the figures are not necessarily to scale, emphasis instead being placed upon illustrating principles of the disclosed embodiments.

FIG. 1 is a schematic diagram of hydrogen generation system, according to an embodiment.

FIG. 2 is a flowchart of a process performed by a base module, according to an embodiment.

FIG. 3 is a flowchart of a process performed by an activation module, according to an embodiment.

FIG. 4 is a flowchart of a process performed by an energy module, according to an embodiment.

FIG. 5 is an illustration of a historical database, according to an embodiment.

FIG. 6 is a flowchart of a process performed by an E.N. base module, according to an embodiment.

FIG. 7 is a flowchart of a process performed by a customer module, according to an embodiment.

FIG. 8 is a flowchart of a process performed by a renewable module, according to an embodiment.

FIG. 9 is a flowchart of a process performed by an analysis module, according to an embodiment.

FIG. 10 is an illustration of a historical energy database, according to an embodiment.

FIG. 11 is a flowchart of a process performed by a C.N. base module, according to an embodiment.

FIG. 12 is a flowchart of a process performed by a request module, according to an embodiment.

FIG. 13 is an illustration of a hydrogen database, according to an embodiment.

FIG. 14 is a flowchart of a process performed by a weather module, according to an embodiment.

FIG. 15 is an illustration of a weather database, according to an embodiment.

FIG. 16 is a flowchart of a method for generating hydrogen using multiple available power sources, according to an embodiment.

FIG. 17 is a block diagram of a machine learning engine for predicting a power cost for one or more available power sources, according to an embodiment.

### DETAILED DESCRIPTION

Hydrogen production using electrolysis is a rapidly growing technology that provides a sustainable alternative to fossil fuels and the resulting environmentally harmful CO₂ emissions. Electrolysis is the process of using electricity to split water into hydrogen and oxygen, with the reaction taking place in a unit called an “electrolyzer.”

Through electrolysis, the electrolyzer creates hydrogen gas. The leftover oxygen is released into the atmosphere or can be captured or stored to supply other industrial processes, including medical gases. The hydrogen gas can either be stored in a compressed form or liquefied. Hydrogen has many attractive properties as an energy carrier including a high energy density (140 MJ/kg) which is more than two times higher than typical solid fuels (50 MJ/kg). Since hydrogen is an energy carrier, it can be used to power any hydrogen fuel cell electric application, including, without limitation, trains, buses, cars, trucks, or data centers.

In its basic form, an electrolyzer contains a cathode (negative charge), an anode (positive charge), and a membrane, such as a proton-permeable membrane (PEM). Each side of this membrane is coated with a suitable electrocatalytic substance to accelerate the electrolysis process. During water electrolysis, electricity is applied to the anode and cathode across PEM, causing the water (H₂0) to split into its component molecules, hydrogen (H₂) and oxygen (O₂).

Different electrolyzers function differently, primarily driven by the types of electrolyte material involved and the ionic species it conducts. In a PEM electrolyzer, the electrolyte is a solid specialty plastic material in the form of a polymer electrolyte membrane. Water reacts to form oxygen and positively charged hydrogen ions (protons) at the anode. The electrons flow through an external circuit, and the hydrogen ions selectively move across the PEM to the cathode. Hydrogen ions combine with electrons from the external circuit to form hydrogen gas at the cathode. The reaction at the anode is 2H₂O→O₂+4H⁺+4e⁻, while the cathode reaction is 4H⁺+4e⁻→2H₂.

Electrolyzers can range in size from small equipment, well-suited for modest-scale distributed hydrogen production, to large-scale, central production facilities capable of being sequenced directly to renewable or other non-greenhouse-gas-emitting forms of electricity production. Electrolyzers may be powered different renewable and non-renewable power sources, which may vary in price per unit of electricity based on changing conditions, including weather conditions and availability of resources. Until now, electrolyzers have had no mechanism for efficiently utilizing different available power sources to reduce the cost of hydrogen production while taking into account the variability of renewable power sources like solar and wind.

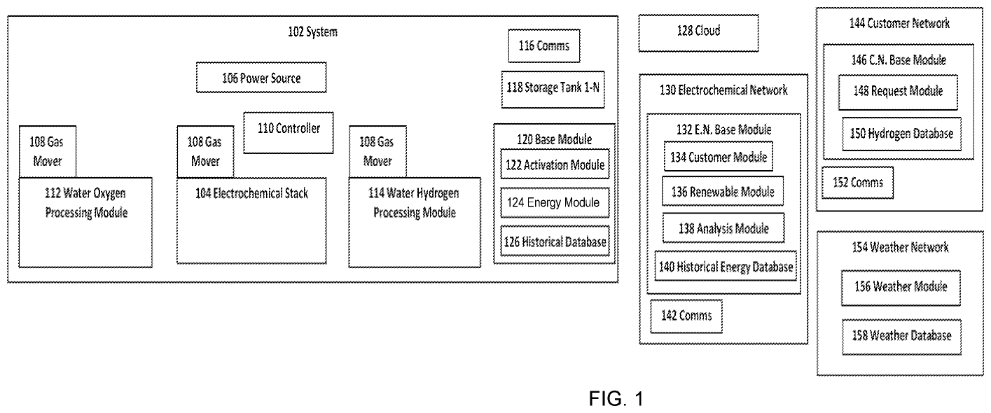

FIG. 1 illustrates a hydrogen generation system 102 including an electrochemical stack 104, a water oxygen processing module 112, and a water hydrogen processing module 114, which are fluidically isolated from each other. The system 102 may also include a water circuit located in the water oxygen processing module 112, an electrochemical module including an electrolyzer electrochemical stack located in the electrochemical stack 104, a hydrogen circuit located in the water hydrogen processing module 114, at least one first fluid connector fluidly connecting the water circuit and the electrolyzer electrochemical stack, and at least one second fluid connector fluidly connecting the electrolyzer electrochemical stack and the hydrogen circuit. The system 102 may further include a power source 106, a plurality of gas movers 108, a controller 110 (e.g., one or more processors), comms 116, and one or more storage tanks 1-N 118.

The electrochemical stack 104 may include a first membrane electrode assembly (MEA), a second membrane electrode assembly (MEA), and a bipolar plate that collectively defines two complete electrochemical cells for hydrogen generation. The electrochemical stack 104 may also include a first end plate and a second end plate that may sandwich the first MEA, the second MEA, and the bipolar plate into contact with one another and direct the flow of fluids into and out of the electrochemical stack 104. While the electrochemical stack 104 is described as including two complete cells—a single bipolar plate and two MEAs—it shall be appreciated that this is for the sake of clarity of explanation only. It shall be more generally understood that the electrochemical stack 104 may include any number of MEAs and bipolar plates useful for meeting the hydrogen generation demands of the system 102 while maintaining separation between pressurized hydrogen and lower pressure water and oxygen flowing through the electrochemical stack 104. Unless otherwise specified or made clear from the context, the electrochemical stack 104 may include more than one bipolar plate, a single MEA, and/or more than two MEAs. In some embodiments, an instance of the bipolar plate may be disposed between the first end plate and the first MEA and/or between the second end plate and the second MEA without departing from the scope of the present disclosure.

In general, the first MEA and the second MEA may be identical to one another. For example, the first MEA may include an anode, a cathode, and a proton exchange membrane (e.g., a PEM electrolyte) a therebetween. Similarly, the second MEA may include an anode, a cathode, and a proton exchange membrane therebetween. The anodes may each comprise an anode catalyst (i.e., electrode) contacting the membrane and an optional anode fluid diffusion layer. The cathodes may each comprise a cathode catalyst (i.e., electrode) contacting the membrane and an optional cathode gas diffusion layer. The anode electrode may comprise any suitable anode catalyst, such as an iridium layer. The anode fluid diffusion layer may comprise a porous material, mesh, or weave, such as a porous titanium sheet or a porous carbon sheet. The cathode electrode may comprise any suitable cathode catalyst, such as a platinum layer. The cathode gas diffusion layer may comprise porous carbon. Other noble metal catalyst layers may also be used for the anode and/or cathode electrodes. The electrolyte may comprise any suitable proton exchange (e.g., hydrogen ion transport) polymer membrane, such as a Nafion® membrane composed of sulfonated tetrafluoroethylene-based fluoropolymer-copolymer with a formula C7HF13O5S·C2F4.

The bipolar plate may be disposed between the cathode of the first MEA and the anode of the second MEA. In general, the bipolar plate may include a substrate, an anode gasket, and a cathode gasket. The substrate has an anode (i.e., water) side and a cathode (i.e., hydrogen) side opposite one another. The anode gasket may be fixed to the anode side of the substrate, and the cathode gasket may be fixed to the cathode side of the substrate. Such fixed positioning of the anode gasket and the cathode gasket on opposite sides of the substrate may facilitate forming two seals that are consistently placed relative to one another and relative to the first MEA and the second MEA on either side of the bipolar plate. The gaskets form a double seal around the active areas, i.e., anode (e.g., water) flow field and cathode (e.g., hydrogen) flow field, located on respective opposite sides of the bipolar plate. Further, or instead, in instances in which an electrochemical stack 104 includes an instance of an MEA between two instances of the bipolar plate, the anode gasket and the cathode gasket may form a double seal along an active area of the MEA. Thus, more generally, it shall be appreciated that the anode gasket and the cathode gasket may form a sealing engagement with one or more MEAs in an electrochemical stack to isolate flows within the electrode stack and, thus, reduce the likelihood that pressurized hydrogen may inadvertently mix with a flow of water and oxygen exiting the electrochemical stack to create a combustible hydrogen-oxygen mixture in the system 102.

The substrate may be formed of any one or more of various different types of materials that are electrically conductive, thermally conductive, and have strength suitable for withstanding the high pressure of hydrogen flowing along the cathode side of the substrate during use. Thus, for example, the substrate may be at least partially formed of one or more of plasticized graphite or carbon composite. Further, or instead, the substrate may be advantageously formed of one or more materials suitable for withstanding prolonged exposure to water on the anode side of the substrate. Accordingly, in some instances, the anode side of the substrate may include an oxidation inhibitor coating that is electrically conductive, examples of which include titanium, titanium oxide, titanium nitride, or a combination thereof. The oxidation inhibitor may generally extend at least along those portions of the anode side of the substrate exposed to water during the operation of the electrochemical stack 104. That is, the oxidation inhibitor may extend at least along the anode flow field inside the anode gasket on the anode side of the substrate. In some implementations, the oxide inhibitor may extend along the plurality of anode ports (i.e., water riser openings) which extend from the anode side to the cathode side of the substrate. The oxidation inhibitor may also be located in the anode plenums, which connect the anode portions to the anode flow field on the anode side of the substrate.

A cathode ring seal may be located around each cathode port (i.e., hydrogen riser opening) on the anode side of the substrate. The cathode ring seal prevents hydrogen from leaking out into the anode flow field on the anode side of the substrate. In contrast, an anode ring seal may be located around each one or more anode ports on the cathode side of the substrate. For example, two anode ports are surrounded by a common anode ring seal to prevent water from flowing into the cathode flow field on the cathode side of the substrate.

The anode flow field includes a plurality of straight and/or curved ribs separated by flow channels oriented to direct a liquid (e.g., purified water) between at least some of the plurality of anode ports, such as may be useful for evenly distributing purified water along the anode of the second MEA. The anode gasket may circumscribe the anode flow field and the plurality of anode ports along the anode side of the substrate to limit the movement of purified water moving along the anode. That is, the anode side of the substrate may be in sealed engagement with the anode of the second MEA via the anode gasket, such that anode channels are located therebetween. Under pressure provided by a source external to the electrochemical stack 104 (e.g., such as the pump of the water circuit), a liquid provided from the first fluid connector flows along the anode channels is directed across the anode of the second MEA, from one instance of the plurality of anode ports to another instance of the plurality of anode ports, where the liquid (e.g., remaining water and oxygen) may be directed out of the electrochemical stack 104 through another first fluid connector.

Additionally, the substrate may include a plurality of cathode ports (i.e., hydrogen riser openings), each extending from the anode side to the cathode side of the substrate. The cathode side of the substrate may include a cathode flow field. The cathode flow field includes a plurality of straight and/or curved ribs separated by cathode flow channels oriented to direct gas (e.g., hydrogen) toward the plurality of cathode ports, such as may be useful for directing pressurized hydrogen formed along the cathode of the first MEA. Cathode plenums may be located between the respective cathode ports and the cathode flow field. The cathode gasket may circumscribe the cathode flow field, the cathode plenums, and the plurality of cathode ports along the cathode side of the substrate to limit movement of the pressurized hydrogen along the cathode. For example, the cathode side of the substrate may be in sealed engagement with the cathode of the first MEA via the cathode gasket, such that the cathode flow channels are defined between the cathode of the first MEA and the cathode side of the substrate. The pressure of the hydrogen formed along the cathode may move the hydrogen along at least a portion of the cathode channels and toward the cathode ports located diagonally opposite the cathode inlet port. The pressurized hydrogen may flow out of the cathode ports and out of the electrochemical stack 104 through the second fluid connector to be processed by the hydrogen circuit.

The anode gasket on the anode side of the substrate and the cathode gasket on the cathode side of the substrate may have different shapes. For example, the anode gasket may extend between the plurality of anode ports and the plurality of cathode ports on the anode side of the substrate. In other words, the anode gasket surrounds the anode ports and the anode flow field on one lateral side but leaves the cathode portions outside its circumscribed area. In an installed position, therefore, the anode gasket may fluidically isolate anode flow from cathode flow.

In contrast, the cathode gasket on the cathode side of the substrate does not extend between the plurality of anode ports and the plurality of cathode ports. In other words, the cathode gasket surrounds the anode ports, the cathode portions, and the cathode flow field. Instead, the anode ring seals isolate the anode portions from the cathode ports and the cathode flow field on the cathode side of the substrate.

In one configuration, the anode flow field and the cathode flow field may have the same shape, albeit on the opposite side of the substrate, to provide the same active area along the first MEA and the second MEA. Thus, taken together, it shall be appreciated that the differences in shape between the anode gasket and the cathode gasket along with positioning of the anode ring seals and the same shape of the anode flow field and the cathode flow field may result in different sealed areas. These different sealed areas are complementary to one another to facilitate fluidically isolating the lower pressure flow of purified water along the anode channels from the pressurized hydrogen flowing along the cathode channels while nevertheless allowing each flow to move through the electrochemical stack 104 and ultimately exit the electrochemical stack 104 along different channels.

In certain implementations, the cathode flow field may be shaped such that a minimum bounding rectangle of the cathode flow field is square. As used in this context, the term minimum bounding rectangle shall be understood to be a minimum rectangle defined by the maximum x- and y-dimensions of the cathode flow field. The plurality of cathode ports may include two cathode ports per substrate which are located in diagonally opposite corners from one another with respect to the minimum bounding rectangle (e.g., within the minimum bounding rectangle). The other two diagonally opposite corners lack the cathode ports. In instances in which the minimum bounding rectangle is square, the diagonal positioning of the cathode ports relative to the minimum bounding rectangle may facilitate the flow of pressurized hydrogen diagonally along the entire cathode flow field while leaving a large margin of the substrate material for strengths against the contained internal hydrogen pressure. Alternatively, the substrate may be a rectangle. The plurality of cathode ports are positioned away from the edges of the substrate such that each one of the plurality of cathode ports is well-reinforced by the material of the substrate between the respective one of the plurality of cathode ports and the closest edge of the substrate.

Given the large pressure differential between the flow of pressurized hydrogen along the cathode channels and the flow of water and oxygen along the anode channels, the electrochemical stack 104 may include the anode fluid diffusion layer disposed in the anode channels and optionally between the anode electrode of the anode of the second MEA and the anode side (e.g., anode ribs) of the substrate. The porous material of the anode fluid diffusion layer may generally permit the flow of water and oxygen through the anode channels without a substantial increase in flow restriction through the anode channels while providing structural support on the anode side of the substrate to resist collapse that may result from the pressure difference on opposite sides of the substrate. For the sake of clear illustration, the porous material is shown along only one anode channel. It shall be understood, however, the that porous material may be disposed inside all of the anode channels in certain implementations.

As an additional, or alternative, safety measure, the electrochemical stack 104 may include a housing disposed about the first MEA, the second MEA, the bipolar plate, the first end plate, and the second end plate. More specifically, the housing may be formed of one or more materials useful for absorbing the force of one or more materials that may become ejected in the event of a failure event (e.g., failure under the force of pressurized hydrogen and/or failure resulting from an explosion of an inadvertent hydrogen-containing mixture). For example, the housing may include one or more metal or aramid (e.g., Kevlar®) fibers.

Having described various features of the electrochemical stack 104, attention is now directed to a description of the operation of the electrochemical stack 104 to form pressurized hydrogen with water and electricity as inputs. In particular, an electric field E (i.e., voltage) may be applied across the electrochemical stack 104 (i.e., between the end plates) from the power source 106. The bipolar plate may electrically connect the first MEA and the second MEA in series with one another such that electrolysis may take place at the first MEA and the second MEA to form a flow of pressurized hydrogen that is maintained fluidically isolated from lower pressure water and oxygen, except for proton exchange occurring through the proton exchange membrane a and the proton exchange membrane.

Purified water (e.g., from the water circuit) may be introduced into the electrochemical stack 104 via the first fluid connector of the system 102. Within the electrochemical stack 104, the purified water may flow along an intake channel that extends through the bipolar plate, among other components, to direct the purified water to the anode of the first MEA and to the anode of the second MEA. With the electric field E applied across the anode and the cathode of the first MEA, the purified water may break down along the anode into protons (H+) and oxygen. The protons (H+) may move from the anode to the cathode through the proton exchange membrane. At the cathode, the protons (H+) may combine with one another to form pressurized hydrogen along the cathode. Through an analogous process, pressurized hydrogen may also be formed along the cathode of the second MEA. The flows of pressurized hydrogen formed by each of the first MEA and the second MEA may combine with one another and flow out of the electrochemical stack 104 via two hydrogen exhaust channels that extends through the bipolar plate, among other components, to ultimately direct the pressurized hydrogen out of the second fluid connector of the system 102 and toward the hydrogen circuit for processing. The flows of oxygen and water along the first anode and the second anode may combine with one another and flow out of the electrochemical stack 104 via the outlet anode ports and an outlet channel that extends through the end plate, among other components, to direct this stream of water and oxygen out of the first fluid connector of the system 102 and toward the water circuit for processing.

As discussed above, the bipolar plate may be in sealed engagement with the cathode of the first MEA and the anode of the second MEA to facilitate keeping pressurized hydrogen formed along the cathode of the first MEA separate from water and oxygen flowing along the anode of the second MEA. This separation is useful for reducing the likelihood of leakage of pressurized hydrogen from the electrochemical stack 104 and, thus, may be useful in addition to, or instead of, any one or more aspects of the modularity of the system 102 with respect to safely producing industrial-scale quantities of hydrogen through electrolysis. Additionally, or alternatively, the sealed engagement facilitated by the bipolar plate may facilitate dismantling the system 102 (e.g., to repair, maintain, and/or replace the electrochemical stack 104) with a lower likelihood of spilling water in the vicinity of the cabinet.

Further, embodiments may include a power source 106, which may include AC energy resources, such as the power grid, wind turbines, solar farms, geothermal power plants, hydroelectric power plants, energy storage (batteries), nuclear power stations, gas power plants, etc. Also, the power source 106 may include DC energy resources, such as wind turbines, solar photovoltaic arrays, energy storage (batteries), DC power grids, etc.

Further, embodiments may include a plurality of gas movers 108 (referred to collectively as the plurality of gas movers 108 and individually as the first gas mover 108, the second gas mover 108, and the third gas mover 108). The plurality of gas movers 108 may include any one or more of various different types of fans (e.g., purge fans), blowers, or compressors unless otherwise specified or made clear from the context. In certain implementations, a powered circuit to each one of the plurality of gas movers 108 may be rated for Class 1 Division 2 operation, as specified according to the National Fire Protection Association (NFPA) 70®, National Electric Code® (NEC), Articles 500-503, 2020, the entire contents of which are incorporated herein by reference. In such implementations, each one of the plurality of gas movers 108 may be disposed within a cabinet. Alternatively, each one of the plurality of gas movers 108 may be mounted externally to the cabinet (e.g., to the roof or sidewall of the cabinet) to reduce the potential for heat or sparks to act as an inadvertent ignition source for contents of the first volume, the second volume, or the third volume.

In general, the first gas mover 108 may be in fluid communication with the first volume, the second gas mover 108 may be in fluid communication with the second volume, and the third gas mover 108 may be in fluid communication with the third volume. For example, each one of the plurality of gas movers 108 may be in fluid communication between an environment outside of the cabinet and a corresponding one of the first volume, the second volume, and the third volume, and may be configured to separately ventilate the respective volume of the cabinet. Additionally, or alternatively, each of the plurality of gas movers 108 may be operable to form negative pressure in a corresponding one of the first volume, the second volume, and the third volume, relative to the environment outside of the cabinet. Such negative pressure may be useful, for example, for drawing air from the environment into the first volume, the second volume, and the third volume to reduce the likelihood that any hydrogen leaking into the first volume, the second volume, or the third volume may accumulate in a concentration above the lower ignition limit of a hydrogen-air mixture at the temperature and pressure associated with the cabinet. Further, negative pressure in the first, second, and third volumes may reduce the likelihood that an ignitable, hydrogen-containing mixture may escape from the cabinet. In certain instances, the cabinet may be insulated to facilitate maintaining one or more components in the first volume, the second volume, and the third volume within a temperature range (e.g., between about 60° C. and about 80° C.) suitable for operation of the electrochemical stack 104.

While the plurality of gas movers 108 may be useful for reducing the likelihood of unsafe conditions forming in the first volume, the second volume, or the third volume, it shall be appreciated that one or more of these volumes may additionally, or alternatively, include area classified components. In such instances, the corresponding volume may be unventilated.

Further, embodiments may include a controller 110, which is in electrical communication at least with one or more components in the first volume, the second volume, or the third volume. In general, the controller 110 may include one or more processors and a non-transitory computer-readable storage medium having stored thereon instructions for causing the one or more processors to control one or more of the startup, operation, or shutdown of any one or more of various aspects of the system 102 to facilitate safe and efficient operation. For example, the controller 110 may include one or more embedded controllers for one or more components in the first volume, the second volume, or the third volume. Additionally, or alternatively, the controller 110 may be in electrical communication at least with the electrochemical stack 104 and a power source 106. Continuing with this example, the controller 110 may interrupt power to the electrochemical stack 104 in the event that an anomalous condition is detected. Further, or instead, the controller 110 may provide power to the electrochemical stack 104 after a startup protocol (e.g., purging the first volume, the second volume, and or the third volume) to reduce the likelihood of igniting a hydrogen-containing mixture in the cabinet.

In some implementations, the cabinet may define a fourth volume, and the controller 110 may be disposed in the fourth volume while being in wireless or wired communication with one or more of the various components described herein as being disposed in one or more of the first volume, the second volume, or the third volume. The fourth volume may be generally located in the vicinity of the first volume, the second volume, and the third volume to facilitate making and/or breaking electrical connections as part of one or more of installation, startup, regular operation, maintenance, or repair. Thus, for example, the fourth volume may be disposed along a top portion of the cabinet and/or along a back portion of the cabinet, with both locations providing useful access to each of the first volume, the second volume, and the third volume while being away from the first door, the second door, and the third door that may be used to provide access to the first volume, the second volume, and the third volume, respectively. Further, or instead, with the controller 110 disposed therein, the fourth volume may be fluidically isolated from each of the first volume, the second volume, and/or the third volume by a roof or back wall of the cabinet to reduce the likelihood of exposing the controller 110 to one or more process fluids during installation, startup, regular operation, shutdown, maintenance, or repair that may compromise the operation of the controller 110.

While the first volume, the second volume, and the third volume have been described as having a negative pressure provided by the plurality of gas movers, the fourth volume may be in fluid communication with a fan operable to generate positive pressure in the fourth volume, relative to an environment outside of the fourth volume, to control the temperature of the controller 110 and/or other components within the fourth volume. Further, or instead, while the fourth volume has been described as housing the controller 110, it shall be appreciated that the fourth volume may house all controls and power electronics for the system 102, as may be useful for reducing the likelihood that inadvertent sparking or overheating of one or more of such components can ignite a hydrogen-containing mixture in one or more of the first volume, the second volume, or the third volume.

In certain implementations, the controller 110 may further, or instead, monitor one or more ambient conditions in the first volume, the second volume, and the third volume to facilitate taking one or more remedial actions before an anomalous condition results in damage to the system 102 and/or to an area near the system 102. In particular, given the potential damage that may be caused by the presence of an ignitable hydrogen-containing mixture within the cabinet, the system 102 may include a plurality of gas sensors (referred to collectively as the plurality of gas sensors and individually as the first gas sensor, second gas sensor, or third gas sensor). Each one of the plurality of gas sensors may include any one or more of various different types of hydrogen sensors, such as one or more of optical fiber sensors, electrochemical hydrogen sensors, thin-film sensors, and the like. To facilitate robust detection of hydrogen within the cabinet, the first gas sensor may be disposed in the first volume, the second gas sensor may be disposed in the second volume, and the third gas sensor may be disposed in the third volume. Each one of the plurality of gas sensors may be calibrated to detect hydrogen concentration levels below the ignition limit of hydrogen to facilitate taking remedial action before an ignition event can occur. Toward this end, the controller 110 may be in electrical communication with each one of the plurality of gas sensors. The non-transitory computer-readable storage media of the controller 110 may have stored thereon instructions for causing one or more processors of the controller 110 to interrupt electrical communication between the power source 106 and equipment in the cabinet based on a signal, received from one or more of the plurality of gas sensors and indicative of a dangerous hydrogen concentration. Additionally, or alternatively, the signal received from one or more of the plurality of gas sensors may indicate a rapid increase in hydrogen concentration.

While the controller 110 may be useful for taking remedial action with respect to potentially hazardous conditions in the cabinet, the system 102 may additionally, or alternatively, include one or more safety features useful for mitigating damage to the system 102 and/or in the vicinity of the system in the event of an explosion. For example, the system 102 may include a pressure relief valve in fluid communication with at least the third volume of the cabinet. The pressure relief valve may be a mechanical valve that is self-opening at a predetermined threshold pressure in the third volume. In some instances, the predetermined threshold pressure may be a pressure increase resulting from leakage of pressurized hydrogen into the third volume. Alternatively, the predetermined threshold pressure may be a high pressure associated with a rapid pressure rise associated with the combustion of a hydrogen-containing mixture. In each case, the pressure relief valve may vent contents of the third volume to the environment to mitigate damage that may otherwise occur.

Further, embodiments may include a water hydrogen processing module 114, which includes a hydrogen circuit, a dryer, and a hydrogen pump. The hydrogen circuit may include a product conduit and a dryer in fluid communication with one another. More specifically, the product conduit may extend through the wall between the second volume and the third volume. The product conduit may be in fluid communication between the inlet portion of the dryer and the second fluid connector of the system 102. Thus, in use, a product stream consisting essentially of hydrogen and water (e.g., water vapor) may move from the anode side of the electrochemical stack 104 to the inlet portion of the dryer via the second fluid connector and the product conduit. As compared to the mixture of oxygen and excess water in the exit flow from the anode portion of the electrochemical stack 104 into the recirculation circuit, the product stream may be at a higher pressure. To reduce the likelihood of hydrogen leaking into the third volume, the connections between the product conduit and each of the second fluid connector and the dryer may include gas-tight seals.

The dryer may be, for example, pressure swing adsorption (PSA), a temperature swing adsorption (TSA) system, or a hybrid PSA-TSA system. The dryer may include one or more beds of a water-adsorbent material, such as activated carbon, silica, zeolite, or alumina. The dryer may include a method for deoxygenation (deoxo) or catalytic purification of the hydrogen stream to remove oxygen. This may be a membrane or pellet bed based form of purification and may be based of Palladium, Platinum, Ruthenium, polymers, or other catalysts known in the industry. As the product mixture consisting essentially of hydrogen and water moves through from the inlet portion to an outlet portion of the dryer, at least a portion of the water may be removed from the product mixture through adsorption of either water or hydrogen in the bed of water-adsorbent material. If hydrogen is adsorbed, then it is removed into the outlet conduit during a pressure and/or temperature swing cycle. If water is adsorbed, then it is removed into a pump conduit during the pressure and/or temperature swing cycle. In some instances, adsorption carried out by the dryer may be passive, without the addition of heat or electricity that could otherwise act as ignition sources of an ignitable hydrogen-containing mixture. In such instances, however, considerations related to backpressure created by the dryer in fluid communication with the electrochemical stack 104 may limit the size and, therefore, the single-pass effectiveness of the dryer in removing moisture from the product stream.

At least in view of such considerations related to the single-pass effectiveness of the dryer, the hydrogen circuit may further, or instead, include a hydrogen pump in fluid communication between the outlet portion and the inlet portion of the dryer to recirculate the product mixture of hydrogen and water for additional passes through the dryer. For example, the dryer may direct dried hydrogen from the outlet portion of the dryer to an outlet conduit that directs the dried hydrogen to a downstream process or storage in an environment outside of the cabinet. Further, or instead, the dryer may direct a portion of the product stream that has not adequately dried from the outlet portion of the dryer to a pump conduit in fluid communication with the hydrogen pump. In certain instances, at least a portion of the water in the product mixture moving along the pump conduit may condense out of the product mixture and collect in a moisture trap in fluid communication with the pump conduit before reaching the hydrogen pump. Such moisture condensed in the moisture trap may be collected and/or directed to an environment outside of the cabinet.

The hydrogen pump may be, for example, an electrochemical pump. As used in this context, an electrochemical pump shall be understood to include a proton exchange membrane (i.e., a PEM electrolyte) disposed between an anode and a cathode. The hydrogen pump may generate protons moveable from the anode through the proton exchange membrane to the cathode form pressurized hydrogen. Thus, such an electrochemical pump may be particularly useful for recirculating hydrogen within the hydrogen circuit at least because the electrochemical pumping provided by the electrochemical pump separates hydrogen from water in the mixture delivered to the hydrogen pump via the pump conduit while also pressurizing the separated hydrogen to facilitate moving the pressurized hydrogen to the inlet portion of the dryer.

Alternatively, the hydrogen pump may comprise another hydrogen pumping and/or separation device, such as a diaphragm compressor or blower or a metal-hydride separator (e.g., which selectively adsorbs hydrogen) which may be used in combination with or instead of the electrochemical hydrogen pump. In one embodiment, a plurality of stages of hydrogen pumping and/or re-pressurization may be used. Each stage may comprise one or more of the diaphragm compressor or blower, the electrochemical pump, or the metal-hydride separator. In one implementation, the stages may be in a cascade (i.e., series) configuration and/or may be located in separate enclosures.

In certain implementations, the hydrogen pump may be in fluid communication with the moisture trap, where the water separated from hydrogen in the hydrogen pump may be collected and/or directed to an environment outside of the cabinet. Additionally, or alternatively, the pressurized hydrogen formed by the hydrogen pump may be directed along a recovery circuit in fluid communication between the hydrogen pump and the inlet portion of the dryer (e.g., via mixing with the product stream in the product conduit) to recirculate the pressurized hydrogen to the dryer. Among other advantages, recirculating the pressurized hydrogen through the dryer facilitates moving hydrogen out of the cabinet through only a single conduit (e.g., the outlet conduit), which may reduce potential failure modes as compared to the use of multiple exit points.

Further, embodiments may include comms 116, or a communication network may be a wired and/or a wireless network. The comms 116, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The comms 116 may allow ubiquitous access to shared pools of configurable system resources and higher-level services that can be rapidly provisioned with minimal management effort, often over the Internet, and relies on sharing of resources to achieve coherence and economies of scale, like a public utility. At the same time, third-party clouds enable organizations to focus on their core businesses instead of expending resources on computer infrastructure and maintenance.

Further, embodiments may include storage tank 1-N 118, which may include a plurality of hydrogen storage tanks to contain the hydrogen created from the system 102. The storage tank 118 may be used to store excess hydrogen created by the system 102 to be used or shipped to users at a later time. The storage tank 118 may be used to contain hydrogen until shipped to users, such as industrial outputs, for example, refinery uses, iron or steel reduction uses, concrete production uses, ammonia synthesis uses, hydrogenated oils uses, other chemical plant type uses, etc.

Further, embodiments may include a base module 120, which begins by connecting to the request module 148. Then the base module 120 is continuously polling to receive a request to activate the electrochemical stack 104 from the request module 148. The base module 120 determines if the request to activate the electrochemical stack 104 was received. If the request to activate the electrochemical stack 104 was not received, the process returns to continuously polling to receive the request to activate the electrochemical stack 104 from the request module 148. If it is determined that the base module 120 received the request from the request module 148 to activate the electrochemical stack 104, then the base module 120 initiates the activation module 122. Then the base module 120 initiates the energy module 124. The base module 120 is then continuously polling for a request for the data stored in the historical database 126 from the analysis module 138. The base module 120 receives a request for the data stored in the historical database 126 from the analysis module 138. Then the base module 120 sends the data stored in the historical database 126 to the analysis module 138, and the process returns to continuously polling to receive a request to activate the electrochemical stack 104 from the request module 148.

Further, embodiments may include an activation module 122, which begins with the activation module 122 being initiated by the base module 120. The activation module 122 connects to the request module 148. Then the activation module 122 sends a request for the data stored in the hydrogen database 150 to the request module 148. The activation module 122 is continuously polling to receive the data stored in the hydrogen database 150 from the request module 148. Then the activation module 122 receives the data stored in the hydrogen database 150 from the request module 148. The activation module 122 stores the received data in the historical database 126. Then the activation module 122 returns to the base module 120.

Further, embodiments may include an energy module 124, which begins with the energy module 124 being initiated by the base module 120. The energy module 124 connects to the analysis module 138. Then the energy module 124 sends a request to the analysis module 138 for the energy source that should be used as the power source 106 for the electrochemical stack 104. The energy module 124 is continuously polling to receive the energy source from the analysis module 138. Then the energy module 124 receives the energy source from the analysis module 138. The energy module 124 sends the energy source to the controller 110. The energy module 124 determines if the customer's hydrogen request was fulfilled. If it is determined that the customer's hydrogen request is fulfilled, then the energy module 124 determines if the power source 106 being used is a renewable energy source. If it is determined that the power source 106 being used is a renewable energy source, then the energy module 124 determines if the storage tanks 118 are filled. If it is determined that the storage tanks 118 are not filled, then the energy module 124 sends a signal to the controller 110 to continue to have the electrochemical stack 104 activated to fill the storage tanks 118. If it is determined that the storage tanks 118 are full or that the power source 106 being used is not a renewable energy source, then the energy module 124 stores the data from the electrochemical stack 104 being active to the historical database 126. If it is determined that the customer's hydrogen request is not fulfilled, then the energy module 124 continues to send a signal to the controller 110 to fulfill the customer's hydrogen request. Then the energy module 124 returns to the base module 120.

Further, embodiments may include a historical database 126 which contains the customer's name, such as client 1, the number of electrochemical stacks the customer is currently operating, such as 10 electrochemical stacks, the hydrogen request, such as 600 kg of hydrogen, the amount of hydrogen generated, such as 600 kg, the amount of hydrogen stored in the storage tanks 118, the energy source used, the cost of the energy source, the date, and the time. In some embodiments, the database may contain a customer ID, the customer's location, the number of active electrochemical stacks, and the number of electrochemical stacks not active. In some embodiments, the cost of the hydrogen may be determined by using the cost of electricity from the grid to power the system 102, the cost of water that is used in the system 102, the cost of employees, the cost of shipping the generated hydrogen, the cost of storing the generated hydrogen, etc. In some embodiments, the energy cost may be the total cost of energy for operating all the electrochemical stacks 104 during the time period in which they are active.

Further, embodiments may include a cloud 128 that may be a wired and/or a wireless network. The cloud 122, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The cloud 122 may allow ubiquitous access to shared pools of configurable system resources and higher-level services that can be rapidly provisioned with minimal management effort, often over the Internet, and relies on sharing of resources to achieve coherence and economies of scale like a public utility. In contrast, third-party clouds enable organizations to focus on their core businesses instead of expending resources on computer infrastructure and maintenance.

Further, embodiments may include an electrochemical network 130, which connects to the system 102, and the customer network 144, which collects data from the system 102 and the customer network 148, and stores the collected data. In some embodiments, the electrochemical network 126 may determine cost-efficient times to produce hydrogen through a customer's system 102 and send a notification to the system 102 to generate hydrogen using the most cost-efficient power source.

Further, embodiments may include an E.N. base module 132, which begins with the E.N. base module 132 initiating the customer module 134. Then the E.N. base module 132 initiates the renewable module 136. Then the E.N. base module 132 initiates the analysis module 138, and the process returns to initiating the customer module 134.

Further, embodiments may include a customer module 134, which begins with the customer module 134 being initiated by the E.N. base module 132. The customer module 134 connects to the request module 148. Then the customer module 134 sends a request for the data stored in the hydrogen database 150 to the request module 148. The customer module 134 is continuously polling to receive the data stored in the hydrogen database 150 from the request module 148. The customer module 134 receives the data stored in the hydrogen database 150 from the request module 148. Then the customer module 134 stores the received data in the historical energy database 140. The customer module 134 returns to the E.N. base module 132.

Further, embodiments may include a renewable module 136, which begins with the renewable module 136 being initiated by the E.N. base module 132. The renewable module 136 connects to the weather module 156. Then the renewable module 136 sends a request for the data stored in the weather database 158. The renewable module 136 is continuously polling to receive the data stored in the weather database 158 from the weather module 156. The renewable module 136 receives the data stored in the weather database 158 from the weather module 156. Then the renewable module 136 filters the historical energy database 140 on the received weather data from the weather module 156. Then the renewable module 136 determines the cost of the energy sources. The renewable module 136 sends the energy sources to the analysis module 138. Then the renewable module 136 returns to the E.N. base module 132.

Further, embodiments may include an analysis module 138, which begins with the analysis module 138 being initiated by the E.N. base module 132. Then the analysis module 138 receives the energy source costs from the renewable module 136. The analysis module 138 connects to the energy module 124. The analysis module 138 receives a request from the energy module 124 for the energy source that should be used as the power source 106 to power the electrochemical stack 104. Then the analysis module 138 determines which energy source should be used as the power source 106 for the electrochemical stack 104. Then the analysis module 138 sends the energy source to the energy module 124. The analysis module 138 sends a request for the data stored in the historical database 126 to the base module 120. The analysis module 138 receives the data stored in the historical database 126 from the base module 120. The analysis module 138 stores the received data in the historical energy database 140. Then the analysis module 138 returns to the E.N. base module 132.

Further, embodiments may include a historical energy database 140, which contains the historical information of the customers, the electrochemical stacks, the hydrogen produced, where the produced hydrogen was sent, the energy source used, and the cost of the energy source, the weather forecast, etc. The database collects the data through the processes described in the renewable module 136 and the analysis module 138, which receives the data from the customer network 144 and the system 102, respectively. The database contains the date, time, the customer's name, such as client 1, the number of electrochemical stacks the customer is currently operating, such as 10 electrochemical stacks, the hydrogen request, such as 600 kg of hydrogen, the amount of hydrogen generated, such as 600 kg, the amount of hydrogen stored in the storage tanks 118, the energy source used, the cost of the energy sources, such as the wind energy cost, the solar energy cost, the grid energy cost, etc., the sun forecast, and the wind forecast. In some embodiments, the database may contain a customer ID, the customer's location, the number of active electrochemical stacks, and the number of electrochemical stacks that are not active. In some embodiments, the cost of the hydrogen may be determined by using the cost of electricity from the grid to power the system 102, the cost of water that is used in the system 102, the cost of employees, the cost of shipping the generated hydrogen, the cost of storing the generated hydrogen, etc. In some embodiments, the energy cost may be the total cost of energy for operating all the electrochemical stacks 104 during the time period in which they are active. In some embodiments, the energy costs may be determined by receiving energy cost data from 3rd parties such as the 3rd party that supplies power to the grid, 3rd party solar farms, 3rd party wind turbines, etc.

Further, embodiments may include comms 146, that may be a wired and/or a wireless network. The comms 142 or communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The comms 146 may allow ubiquitous access to shared pools of configurable system resources and higher-level services that can be rapidly provisioned with minimal management effort, often over the Internet, and relies on sharing of resources to achieve coherence and economies of scale, like a public utility. At the same time, third-party clouds enable organizations to focus on their core businesses instead of expending resources on computer infrastructure and maintenance.

Further, embodiments may include a customer network 144, which allows the users or customers to input their hydrogen requests to the system 102 through the C.N. base module 146. The customer network 148 allows the customers or users to share information or data with the system 102 and electrochemical network 134.

Further, embodiments may include a C.N. base module 146, which begins by continuously polling for the user input. Then user inputs the hydrogen request. Then the C.N. base module 146 stores the hydrogen request in the hydrogen database 150. The C.N. base module 146 initiates the request module 148.

Further, embodiments may include a request module 148, which begins by being initiated by the C.N. base module 146. The request module 148 connects to the system base module 120. Then the request module 148 sends a request to activate the electrochemical stack 104 to the base module 120. The request module 148 is continuously polling for a request for the data stored in the hydrogen database 150 from the activation module 122. The request module 148 receives a request for the data stored in the hydrogen database 150 from the activation module 122. Then the request module 148 sends the data stored in the hydrogen database 150 to the activation module 122. The request module 148 connects to the customer module 134. Then the request module 148 is continuously polling for a request from the customer module 134 for the data stored in the hydrogen database 150. The request module 148 receives a request for the data stored in the hydrogen database 150 from the customer module 134. The request module 148 sends the data stored in the hydrogen database 150 to the customer module 134. The request module 148 returns to the C.N. base module 146.

Further, embodiments may include a hydrogen database 150 which contains the customer's name, such as client 1, the number of electrochemical stacks the customer is currently operating, such as 10 electrochemical stacks, the hydrogen request, such as 600 kg of hydrogen, the date, and the time. In some embodiments, the database may contain a customer ID, the customer's location, the number of active electrochemical stacks, and the number of electrochemical stacks not active. In some embodiments, the hydrogen request may be daily, hourly, weekly, monthly, quarterly, yearly, etc. In some embodiments, the user may not have to input the hydrogen request, such as having an automated system that may determine the hydrogen request by reading a database of the customer's orders, required shipments, etc.

Further, embodiments may include comms 152 may be a wired and/or a wireless network. The comms 158, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The comms 158 may allow ubiquitous access to shared pools of configurable system resources and higher-level services that can be rapidly provisioned with minimal management effort, often over the Internet, and relies on sharing of resources to achieve coherence and economies of scale, like a public utility. At the same time, third-party clouds enable organizations to focus on their core businesses instead of expending resources on computer infrastructure and maintenance.

Further, embodiments may include a weather network 154, which includes a weather module 156, and a weather database 158, which allows the electrochemical network 130 to request and receive weather information. In some embodiments, the weather network 154 may be a 3rd party network in which weather information is provided for the day, week, or month. In some embodiments, the weather network 154 may provide real-time weather information.

Further, embodiments may include a weather module 156, which begins by continuously polling to receive a request for the data stored in the weather database 158 from the renewable module 136. Then the weather module 156 receives a request from the renewable module 136 for the data stored in the weather database 158. Then the weather module 156 sends the data stored in the weather database 158 to the renewable module 136, and the process returns to continuously polling to receive a request from the renewable module 136.

Further, embodiments may include a weather database 158, which contains information about the weather forecast, such as the date and time, a sun forecast and/or the wind forecast. In some embodiments, the sun forecast may use the UV index and/or an indication of cloud cover (sunny, partly sunny, cloudy, partly cloudy, overcast) to determine the amount of sunlight for the day. In some embodiments, the wind forecast may use the peak strength of the wind during the day. The database is used to determine if the weather forecast for the day allows for the use of renewable energy such as solar panels or wind turbines. In some embodiments, the weather forecast may be updated in real-time by the weather network 154.

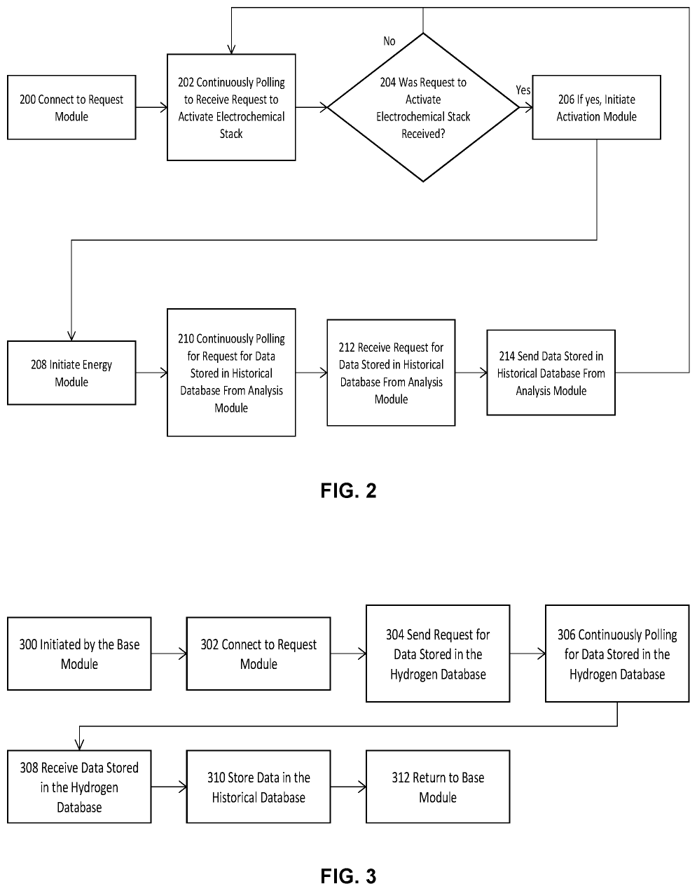

FIG. 2 illustrates the base module 120. The process begins with the base module 120 connecting, at step 200, to the request module 148. Then the base module 120 is continuously polling, at step 202, to receive a request to activate the electrochemical stack 104 from the request module 148. For example, the base module 120 is continuously polling to receive a request to activate the electrochemical stack 104 to produce hydrogen for the customer in order to fulfill the customer's hydrogen request. The base module 120 determines, at step 204, if the request to activate the electrochemical stack 104 was received. If the request to activate the electrochemical stack 104 was not received, the process returns to continuously polling to receive the request to activate the electrochemical stack 104 from the request module 148. For example, the base module 120 receives a request to activate the electrochemical stack 104 to produce hydrogen for the customer in order to fulfill the customer's hydrogen request. If it is determined that the base module 120 received the request from the request module 148 to activate the electrochemical stack 104, then the base module 120 initiates, at step 206, the activation module 122. For example, the activation module 122 may begin with the activation module 122 being initiated by the base module 120. The activation module 122 connects to the request module 148. Then the activation module 122 sends a request for the data stored in the hydrogen database 150 to the request module 148. The activation module 122 is continuously polling to receive the data stored in the hydrogen database 150 from the request module 148. Then the activation module 122 receives the data stored in the hydrogen database 150 from the request module 148. The activation module 122 stores the received data in the historical database 126. Then the activation module 122 returns to the base module 120. Then the base module 120 initiates, at step 208, the energy module 124.

For example, the energy module 124 may begin with the energy module 124 being initiated by the base module 120. The energy module 124 connects to the analysis module 138. Then the energy module 124 sends a request to the analysis module 138 for the energy source that should be used as the power source 106 for the electrochemical stack 104. The energy module 124 is continuously polling to receive the energy source from the analysis module 138. Then the energy module 124 receives the energy source from the analysis module 138. The energy module 124 sends the energy source to the controller 110. The energy module 124 determines if the customer hydrogen request was fulfilled.

If it is determined that the customer's hydrogen request is fulfilled, then the energy module 124 determines if the power source 106 being used is a renewable energy source. If it is determined that the power source 106 being used is a renewable energy source, then the energy module 124 determines if the storage tanks 118 are filled. If it is determined that the storage tanks 118 are not filled, then the energy module 124 sends a signal to the controller 110 to continue to have the electrochemical stack 104 activated to fill the storage tanks 118. If it is determined that the storage tanks 118 are full or that the power source 106 being used is not a renewable energy source, then the energy module 124 stores the data from the electrochemical stack 104 being active to the historical database 126. If it is determined that the customer's hydrogen request is not fulfilled then the energy module 124 continues to send a signal to the controller 110 to fulfill the customer's hydrogen request.

Then the energy module 124 returns to the base module 120. The base module 120 is then continuously polling, at step 210, for a request for the data stored in the historical database 126 from the analysis module 138. For example, the base module 120 is continuously polling to receive a request from the analysis module 138 to send the data stored in the historical database 126, such as the customer's name, such as client 1, the number of electrochemical stacks the customer is currently operating, such as 10 electrochemical stacks, the hydrogen request, such as 600 kg of hydrogen, the amount of hydrogen generated, such as 600 kg, the amount of hydrogen stored in the storage tanks 118, the energy source used, the cost of the energy source, the date and the time. In some embodiments, the database may contain a customer ID, the customer's location, the number of active electrochemical stacks, and the number of electrochemical stacks not active.

In some embodiments, the cost of the hydrogen may be determined by using the cost of electricity from the grid to power the system 102, the cost of water that is used in the system 102, the cost of employees, the cost of shipping the generated hydrogen, the cost of storing the generated hydrogen, etc. In some embodiments, the energy cost may be the total cost of energy for operating all the electrochemical stacks 104 during the time period in which they are active. The base module 120 receives, at step 212, a request for the data stored in the historical database 126 from the analysis module 138. For example, the base module receives a request to send the data in the historical database 126 such as the customer's name, such as client 1, the number of electrochemical stacks the customer is currently operating, such as 10 electrochemical stacks, the hydrogen request, such as 600 kg of hydrogen, the amount of hydrogen generated, such as 600 kg, the amount of hydrogen stored in the storage tanks 118, the energy source used, the cost of the energy source, the date and the time.

In some embodiments, the database may contain a customer ID, the customer's location, the number of active electrochemical stacks, and the number of electrochemical stacks that are not active. In some embodiments, the cost of the hydrogen may be determined by using the cost of electricity from the grid to power the system 102, the cost of water that is used in the system 102, the cost of employees, the cost of shipping the generated hydrogen, the cost of storing the generated hydrogen, etc. In some embodiments, the energy cost may be the total cost of energy for operating all the electrochemical stacks 104 during the time period in which they are active. Then the base module 120 sends, at step 214, the data stored in the historical database 126 to the analysis module 138, and the process returns to continuously polling to receive a request to activate the electrochemical stack 104 from the request module 148.

For example, the base module 120 sends the data stored in the historical database 126 such as the customer's name, such as client 1, the number of electrochemical stacks the customer is currently operating, such as 10 electrochemical stacks, the hydrogen request, such as 600 kg of hydrogen, the amount of hydrogen generated, such as 600 kg, the amount of hydrogen stored in the storage tanks 118, the energy source used, the cost of the energy source, the date, and the time. In some embodiments, the database may contain a customer ID, the customer's location, the number of active electrochemical stacks, and the number of electrochemical stacks that are not active. In some embodiments, the cost of the hydrogen may be determined by using the cost of electricity from the grid to power the system 102, the cost of water that is used in the system 102, the cost of employees, the cost of shipping the generated hydrogen, the cost of storing the generated hydrogen, etc. In some embodiments, the energy cost may be the total cost of energy for operating all the electrochemical stacks 104 during the time period in which they are active.

FIG. 3 illustrates the activation module 122. The process begins with the activation module 122 being initiated, at step 300, by the base module 120. The activation module 122 connects, at step 302, to the request module 148. Then the activation module 122 sends, at step 304, a request for the data stored in the hydrogen database 150 to the request module 148. For example, the activation module 122 is sending a request for data such as the customer's name, such as client 1, the number of electrochemical stacks the customer is currently operating, such as 10 electrochemical stacks, the hydrogen request, such as 600 kg of hydrogen, the date, and the time. In some embodiments, the database may contain a customer ID, the customer's location, the number of active electrochemical stacks, and the number of electrochemical stacks not active. In some embodiments, the hydrogen request may be daily, hourly, weekly, monthly, quarterly, yearly, etc. In some embodiments, the user may not have to input the hydrogen request, such as having an automated system that may determine the hydrogen request by reading a database of the customer's orders, required shipments, etc.

The activation module 122 is continuously polling, at step 306, to receive the data stored in the hydrogen database 150 from the request module 148. For example, the activation module 122 is continuously polling to receive data such as the customer's name, such as client 1, the number of electrochemical stacks the customer is currently operating, such as 10 electrochemical stacks, the hydrogen request, such as 600 kg of hydrogen, the date, and the time. In some embodiments, the database may contain a customer ID, the customer's location, the number of active electrochemical stacks, and the number of electrochemical stacks not active. In some embodiments, the hydrogen request may be daily, hourly, weekly, monthly, quarterly, yearly, etc. In some embodiments, the user may not have to input the hydrogen request, such as having an automated system that may determine the hydrogen request by reading a database of the customer's orders, required shipments, etc. Then the activation module 122 receives, at step 308, the data stored in the hydrogen database 150 from the request module 148.

For example, the activation module receives data such as the customer's name, such as client 1, the number of electrochemical stacks the customer is currently operating, such as 10 electrochemical stacks, the hydrogen request, such as 600 kg of hydrogen, the date, and the time. In some embodiments, the database may contain a customer ID, the customer's location, the number of active electrochemical stacks, and the number of electrochemical stacks not active. In some embodiments, the hydrogen request may be daily, hourly, weekly, monthly, quarterly, yearly, etc. In some embodiments, the user may not have to input the hydrogen request, such as having an automated system that may determine the hydrogen request by reading a database of the customer's orders, required shipments, etc.

The activation module 122 stores, at step 310, the received data in the historical database 126. For example, the activation module stores the data, such as the customer's name, such as client 1, the number of electrochemical stacks the customer is currently operating, such as 10 electrochemical stacks, the hydrogen request, such as 600 kg of hydrogen, the date, and the time in the historical database 126. In some embodiments, the database may contain a customer ID, the customer's location, the number of active electrochemical stacks, and the number of electrochemical stacks not active. In some embodiments, the hydrogen request may be daily, hourly, weekly, monthly, quarterly, yearly, etc. In some embodiments, the user may not have to input the hydrogen request, such as having an automated system that may determine the hydrogen request by reading a database of the customer's orders, required shipments, etc. Then the activation module 122 returns, at step 312, to the base module 120.

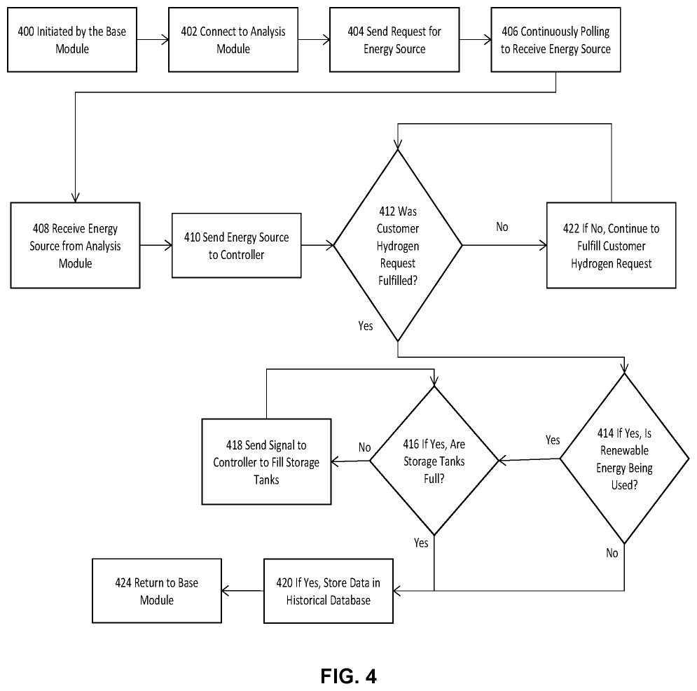

FIG. 4 illustrates the energy module 124. The process begins with the energy module 124 being initiated, at step 400, by the base module 120. The energy module 124 connects, at step 402, to the analysis module 138. Then the energy module 124 sends, at step 404, a request to the analysis module 138 for the energy source that should be used as the power source 106 for the electrochemical stack 104. For example, the request the energy module 124 sends is to determine which of the energy sources, such as wind, solar, grid, etc., that the system 102 should use as the power source 106 to power the electrochemical stack 104 in order to utilize the lowest cost option. The energy module 124 is continuously polling, at step 406, to receive the energy source from the analysis module 138.

For example, the energy module 124 is continuously polling to receive the lowest cost option of the available energy sources, such as wind, solar, grid, etc. Then the energy module 124 receives, at step 408, the energy source from the analysis module 138. For example, if the energy module 124 receives the energy source of the lowest cost option, such as solar energy and solar energy would be the energy source that is received by the energy module 124. The energy module 124 sends, at step 410, the energy source to the controller 110. For example, the energy module 124 sends a signal to the controller 110 to adjust or change the power source 106 that is used for solar energy. The energy module 124 determines, at step 412, if the customer hydrogen request was fulfilled. For example, the energy module 124 may be continuously determining if the customer hydrogen request was fulfilled by determining if the total amount of hydrogen produced by the system 102 matches the customer hydrogen request stored in the historical database 126.

If it is determined that the customer's hydrogen request is fulfilled, then the energy module 124 determines, at step 414, if the power source 106 being used is a renewable energy source. For example, if the energy module 124 determines that there is a match between the amount of hydrogen produced by the system 102 matches the customer's hydrogen request stored in the historical database 126, it can be determined that the customer's hydrogen request was fulfilled or complete. Then the energy module 124 determines if the power source being used is a renewable energy source such as wind, solar, etc. If it is determined that renewable energy is being used, the process continues to determine if the storage tanks 118 are filled. If renewable energy is not being used, then the process continues to store the data from the hydrogen production in the historical database 126. If it is determined that the power source 106 being used is a renewable energy source, then the energy module 124 determines, at step 416, if the storage tanks 118 are filled. For example, if renewable energy is being used to produce hydrogen, it may be cheaper to fill the storage tanks 118 while using renewable energy rather than power from the grid.

If it is determined that the storage tanks 118 are not filled, then the energy module 124 sends, at step 418, a signal to the controller 110 to continue to have the electrochemical stack 104 activated to fill the storage tanks 118. For example, the energy module 124 sends a signal to the controller 110 to continue to produce hydrogen and store the excess hydrogen in the storage tanks 118 since using the renewable energy may be a lower-cost option for hydrogen production than using the grid as the power source 106. If it is determined that the storage tanks 118 are full or that the power source 106 being used is not a renewable energy source, then the energy module 124 stores, at step 420, the data from the electrochemical stack 104 being active to the historical database 126. If it is determined that the customer's hydrogen request is not fulfilled, then the energy module 124 continues, at step 422, to send a signal to the controller 110 to fulfill the customer's hydrogen request. For example, the energy module 124 sends a signal to the controller 110 to continue to fulfill the customer's hydrogen request, and the process returns to determining if the customer's request was fulfilled or completed. Then the energy module 124 returns, at step 424, to the base module 120.

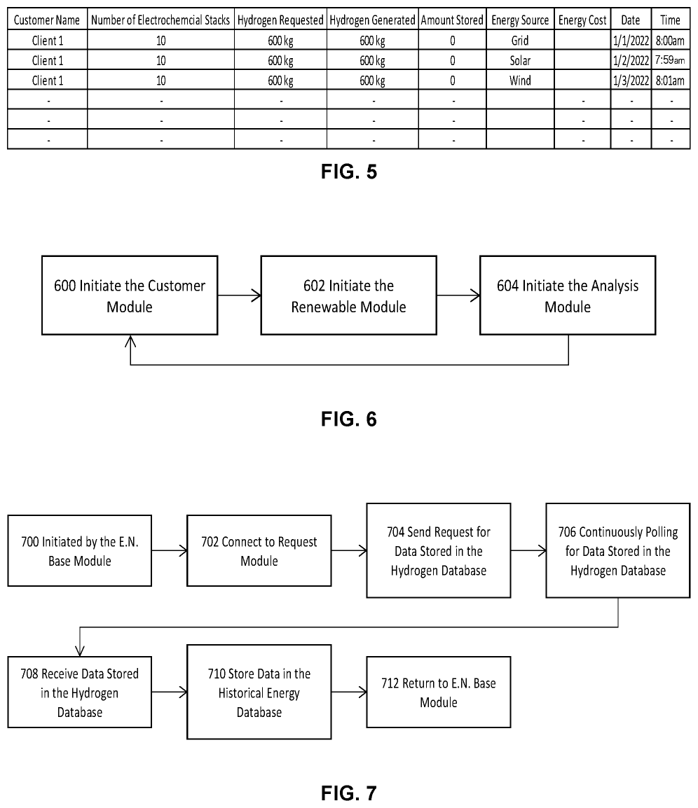

FIG. 5 illustrates the historical database 126. The database may contain the customer's name, such as client 1, the number of electrochemical stacks the customer is currently operating, such as 10 electrochemical stacks, the hydrogen request, such as 600 kg of hydrogen, the amount of hydrogen generated, such as 600 kg, the amount of hydrogen stored in the storage tanks 118, the energy source used, the cost of the energy source, the date, and the time. In some embodiments, the database may contain a customer ID, the customer's location, the number of active electrochemical stacks, and the number of electrochemical stacks that are not active. In some embodiments, the cost of the hydrogen may be determined by using the cost of electricity from the grid to power the system 102, the cost of water that is used in the system 102, the cost of employees, the cost of shipping the generated hydrogen, the cost of storing the generated hydrogen, etc. In some embodiments, the energy cost may be the total cost of energy for operating all of the electrochemical stacks 104 during the time period in which they are active.

FIG. 6 illustrates the E.N. base module 132. The process begins with the E.N. base module 132 initiates, at step 600, the customer module 134. For example, the customer module 134 may begin with the customer module 134 being initiated by the E.N. base module 132. The customer module 134 connects to the request module 148. Then the customer module 134 sends a request for the data stored in the hydrogen database 150 to the request module 148. The customer module 134 is continuously polling to receive the data stored in the hydrogen database 150 from the request module 148. The customer module 134 receives the data stored in the hydrogen database 150 from the request module 148. Then the customer module 134 stores the received data in the historical energy database 140. The customer module 134 returns to the E.N. base module 132. Then the E.N. base module 132 initiates, at step 602, the renewable module 136.

For example, the renewable module 136 may begin with the renewable module 136 being initiated by the E.N. base module 132. The renewable module 136 connects to the weather module 156. Then the renewable module 136 sends a request for the data stored in the weather database 158. The renewable module 136 is continuously polling to receive the data stored in the weather database 158 from the weather module 156. The renewable module 136 receives the data stored in the weather database 158 from the weather module 156. Then the renewable module 136 filters the historical energy database 140 on the received weather data from the weather module 156. Then the renewable module 136 determines the cost of the energy sources. The renewable module 136 sends the energy sources to the analysis module 138. Then the renewable module 136 returns to the E.N. base module 132. Then the E.N. base module 132 initiates, at step 604, the analysis module 138, and the process returns to initiating the customer module 134.

For example, the analysis module 138 may begin with the analysis module 138 being initiated by the E.N. base module 132. Then the analysis module 138 receives the energy source costs from the renewable module 136. The analysis module 138 connects to the energy module 124. The analysis module 138 receives a request from the energy module 124 for the energy source that should be used as the power source 106 to power the electrochemical stack 104. Then the analysis module 138 determines which energy source should be used as the power source 106 for the electrochemical stack 104. Then the analysis module 138 sends the energy source to the energy module 124. The analysis module 138 sends a request for the data stored in the historical database 126 to the base module 120. The analysis module 138 receives the data stored in the historical database 126 from the base module 120. The analysis module 138 stores the received data in the historical energy database 140. Then the analysis module 138 returns to the E.N. base module 132.

FIG. 7 illustrates the customer module 134. The process begins with the customer module 134 being initiated, at step 700, by the E.N. base module 132. The customer module 134 connects, at step 702, to the request module 148. Then the customer module 134 sends, at step 702, a request for the data stored in the hydrogen database 150 to the request module 148. For example, the customer module 134 is sending a request for data such as the customer's name, such as client 1, the number of electrochemical stacks the customer is currently operating, such as 10 electrochemical stacks, the hydrogen request, such as 600 kg of hydrogen, the date, and the time. The customer module 134 is continuously polling, at step 704, to receive the data stored in the hydrogen database 150 from the request module 148. The customer module 134 is continuously polling to receive the data such as the customer's name, such as client 1, the number of electrochemical stacks the customer is currently operating, such as 10 electrochemical stacks, the hydrogen request, such as 600 kg of hydrogen, the date, and the time. The customer module 134 receives, at step 706, the data stored in the hydrogen database 150 from the request module 148. The customer module 134 receives data such as the customer's name, such as client 1, the number of electrochemical stacks the customer is currently operating, such as 10 electrochemical stacks, the hydrogen request, such as 600 kg of hydrogen, the date, and the time. Then the customer module 134 stores, at step 708, the received data in the historical energy database 140. The customer module 134 stores the data such as the customer's name, such as client 1, the number of electrochemical stacks the customer is currently operating, such as 10 electrochemical stacks, the hydrogen request, such as 600 kg of hydrogen, the date, and the time in the historical energy database 140. The customer module 134 returns, at step 712, to the E.N. base module 132.

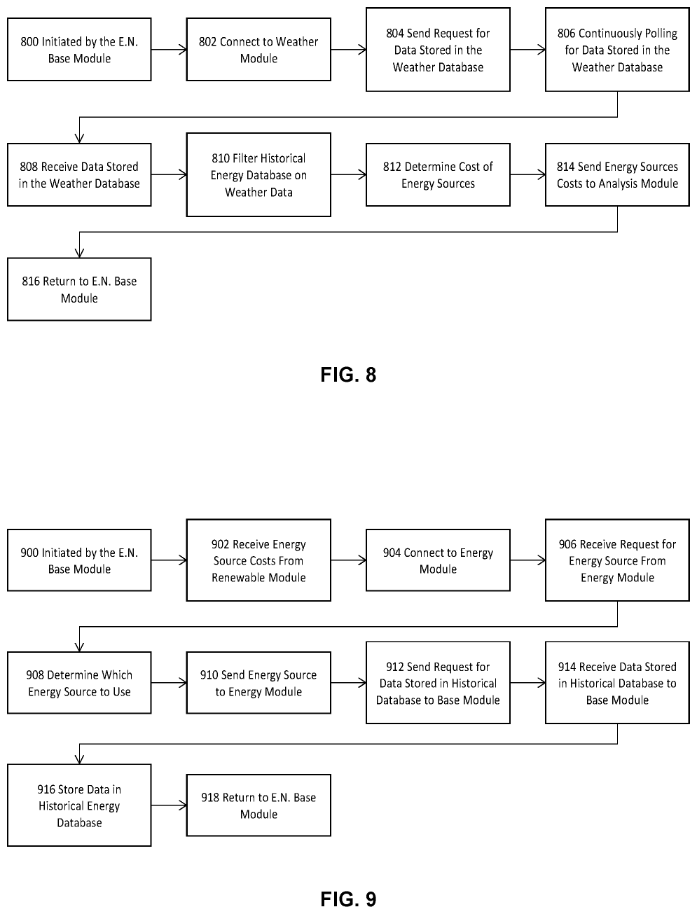

FIG. 8 illustrates the renewable module 136. The process begins with the renewable module 136 being initiated, at step 800, by the E.N. base module 132. The renewable module 136 connects, at step 802, to the weather module 156. Then the renewable module 136 sends, at step 804, a request for the data stored in the weather database 158. For example, the renewable module 136 sends a request for data such as the information about the weather forecast, such as the date and time, the sun forecast, and the wind forecast. In some embodiments, the sun forecast may use the UV index to determine the amount of sunlight for the day. In some embodiments, the wind forecast may use the peak strength of the wind during the day. The database is used to determine if the weather forecast for the day allows for the use of renewable energy such as solar panels or wind turbines.

In some embodiments, the weather forecast may be updated in real-time by the weather network 154. The renewable module 136 is continuously polling, at step 806, to receive the data stored in the weather database 158 from the weather module 156. For example, the renewable module 136 is continuously polling to receive data such as the information about the weather forecast, such as the date and time, the sun forecast, and the wind forecast. In some embodiments, the sun forecast may use the UV index to determine the amount of sunlight for the day. In some embodiments, the wind forecast may use the peak strength of the wind during the day. The database is used to determine if the weather forecast for the day allows for the use of renewable energy such as solar panels or wind turbines. In some embodiments, the weather forecast may be updated in real-time by the weather network 154.

The renewable module 136 receives, at step 808, the data stored in the weather database 158 from the weather module 156. For example, the renewable module 136 receives the data stored in the weather database 158, such as the information about the weather forecast, such as the date and time, the sun forecast, and the wind forecast. In some embodiments, the sun forecast may use the UV index to determine the amount of sunlight for the day. In some embodiments, the wind forecast may use the peak strength of the wind during the day. The database is used to determine if the weather forecast for the day allows for the use of renewable energy such as solar panels or wind turbines. In some embodiments, the weather forecast may be updated in real-time by the weather network 154.

Then the renewable module 136 filters, at step 810, the historical energy database 140 on the received weather data from the weather module 156. For example, the renewable module 136 filters the historical energy database 140 on the received weather data. For example, if the weather forecast for the day is cloudy with winds at one mph, the historical energy database 140 is filtered on the data entries that have the weather forecast as cloudy with one mph winds. Another example may be if the weather forecast for the day is sunny with winds at two mph. The historical energy database 140 is filtered on the data entries that have the weather forecast as sunny with two mph winds. Then the renewable module 136 determines, at step 812, the cost of the energy sources.

For example, the renewable module 136 determines the cost of the energy sources by determining the average cost of the solar energy, wind energy, and grid energy with similar weather conditions stored in the historical energy database 140. For example, if the weather conditions are sunny and the data entries for the cost of solar energy are $3.00 per watt per hour, $2.75 per watt per hour, and $3.25 per watt per hour, then the average cost for solar energy is $3.00 per watt per hour on a sunny day. Similarly, if the data entries for the cost of wind energy on a sunny day with little to no wind, such as 2 mph, are $4.75 per watt per hour, $4.50 per watt per hour, and $5.00 per watt per hour, then the average cost of wind energy on a sunny day with little to no wind, such as 2 mph, would be $4.75. The renewable module 136 sends, at step 814, the energy sources to the analysis module 138. For example, the renewable module 136 sends the costs of the energy sources, such as solar energy is $3.00 per watt per hour, wind energy is $4.75 per watt per hour, and grid energy is $3.50 per watt per hour, to the analysis module 138. Then the renewable module 136 returns, at step 816, to the E.N. base module 132.

FIG. 9 illustrates the analysis module 138. The process begins with the analysis module 138 being initiated, at step 900, by the E.N. base module 132. Then the analysis module 138 receives, at step 902, the energy source costs from the renewable module 136. For example, the analysis module 138 receives the costs of the energy sources, such as solar energy is $3.00 per watt per hour, wind energy is $4.75 per watt per hour, and grid energy is $3.50 per watt per hour, from the renewable module 136. The analysis module 138 connects, at step 904, to the energy module 124. The analysis module 138 receives, at step 906, a request from the energy module 124 for the energy source that should be used as the power source 106 to power the electrochemical stack 104. For example, the request the analysis module 138 receives is to determine which of the energy sources, such as wind, solar, grid, etc., that the system 102 should use as the power source 106 to power the electrochemical stack 104 in order to utilize the lowest cost option. Then the analysis module 138 determines, at step 908, which energy source should be used as the power source 106 for the electrochemical stack 104.

For example, the analysis module 138 may determine which of the energy sources, such as wind, solar, grid, etc., are the lowest cost option by determining which of the received energy source costs is the lowest. For example, if the analysis module 138 receives the energy costs, such as solar energy is $3.00 per watt per hour, wind energy is $4.75 per watt per hour, and grid energy is $3.50 per watt per hour, then the lowest cost option would be solar energy, and solar energy would be the energy source that is sent to the energy module 124. Then the analysis module 138 sends, at step 910, the energy source to the energy module 124. For example, if the analysis module 138 receives the energy costs, such as solar energy is $3.00 per watt per hour, wind energy is $4.75 per watt per hour, and grid energy is $3.50 per watt per hour, then the lowest cost option would be solar energy, and solar energy would be the energy source that is sent to the energy module 124.

The analysis module 138 sends, at step 912, a request for the data stored in the historical database 126 to the base module 120. For example, the analysis module sends a request to receive data such as the customer's name, such as client 1, the number of electrochemical stacks the customer is currently operating, such as 10 electrochemical stacks, the hydrogen request, such as 600 kg of hydrogen, the amount of hydrogen generated, such as 600 kg, the amount of hydrogen stored in the storage tanks 118, the energy source used, the cost of the energy source, the date, and the time. The analysis module 138 receives, at step 914, the data stored in the historical database 126 from the base module 120. For example, the analysis module 138 receives the data such as the customer's name, such as client 1, the number of electrochemical stacks the customer is currently operating, such as 10 electrochemical stacks, the hydrogen request, such as 600 kg of hydrogen, the amount of hydrogen generated, such as 600 kg, the amount of hydrogen stored in the storage tanks 118, the energy source used, the cost of the energy source, the date, and the time.

The analysis module 138 stores, at step 916, the received data in the historical energy database 140. For example, the analysis module 138 stores the data such as the customer's name, such as client 1, the number of electrochemical stacks the customer is currently operating, such as 10 electrochemical stacks, the hydrogen request, such as 600 kg of hydrogen, the amount of hydrogen generated, such as 600 kg, the amount of hydrogen stored in the storage tanks 118, the energy source used, the cost of the energy source, the date, and the time in the historical energy database 140. Then the analysis module 138 returns, at step 918, to the E.N. base module 132.

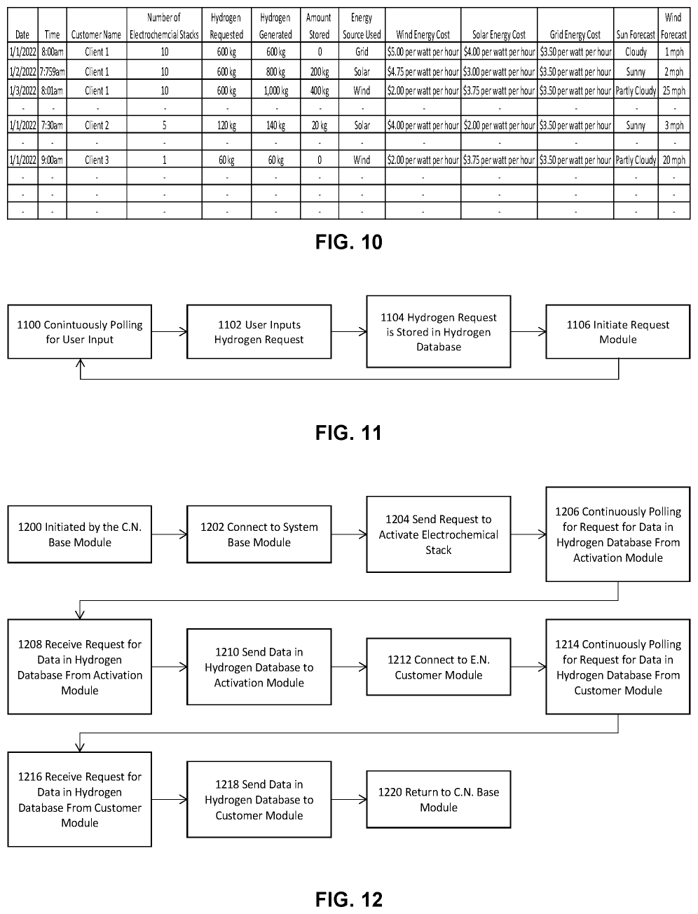

FIG. 10 illustrates the historical energy database 140. The database contains the historical information of the customers, the electrochemical stacks, the hydrogen produced, where the produced hydrogen was sent, the energy source used and the cost of the energy source, the weather forecast, etc. The database collects the data through the processes described in the renewable module 136 and the analysis module 138, which receives the data from the customer network 144 and the system 102, respectively. The database contains the date, time, the customer's name, such as client 1, the number of electrochemical stacks the customer is currently operating, such as 10 electrochemical stacks, the hydrogen request, such as 600 kg of hydrogen, the amount of hydrogen generated, such as 600 kg, the amount of hydrogen stored in the storage tanks 118, the energy source used, the cost of the energy sources, such as the wind energy cost, the solar energy cost, the grid energy cost, etc., the sun forecast, and the wind forecast. In some embodiments, the database may contain a customer ID, the customer's location, the number of active electrochemical stacks, and the number of electrochemical stacks not active. In some embodiments, the cost of the hydrogen may be determined by using the cost of electricity from the grid to power the system 102, the cost of water that is used in the system 102, the cost of employees, the cost of shipping the generated hydrogen, the cost of storing the generated hydrogen, etc. In some embodiments, the energy cost may be the total cost of energy for operating all the electrochemical stacks 104 during the time period in which they are active. In some embodiments, the energy costs may be determined by receiving energy cost data from 3rd parties such as the 3rd party that supplies power to the grid, 3rd party solar farms, 3rd party wind turbines, etc.

FIG. 11 illustrates the C.N. base module 146. The process begins with the C.N. base module 146 continuously polling, at step 1100, for the user input. For example, the user input may be the customer's hydrogen request for the day, such as 600 kg of hydrogen, that the customer requires. In some embodiments, the user inputs may be inputted throughout the day, for the entire day, week, month, quarter, year, year, etc. In some embodiments, the user inputs may be sent to the system 102 in order to let the system 102 know how much hydrogen needs to be produced and informs the system 102 how long the electrochemical stacks 104 should be activated for. Then user inputs, at step 1102, the hydrogen request. For example, the user input may be the customer's hydrogen request for the day, such as 600 kg of hydrogen, that the customer requires. In some embodiments, the user inputs may be inputted throughout the day, for the entire day, week, month, quarter, year, year, etc. In some embodiments, the user inputs may be sent to the system 102 in order to let the system 102 know how much hydrogen needs to be produced and informs the system 102 how long the electrochemical stacks 104 should be activated for. Then the C.N. base module 146 stores, at step 1104, the hydrogen request in the hydrogen database 150. For example, the hydrogen database 150 may contain the customer's name, such as client 1, the number of electrochemical stacks the customer is currently operating, such as 10 electrochemical stacks, the hydrogen request, such as 600 kg of hydrogen, the date, and the time. In some embodiments, the database may contain a customer ID, the customer's location, the number of active electrochemical stacks, and the number of electrochemical stacks that are not active. In some embodiments, the hydrogen request may be daily, hourly, weekly, monthly, quarterly, yearly, etc. In some embodiments, the user may not have to input the hydrogen request, such as having an automated system that may determine the hydrogen request by reading a database of the customer's orders, required shipments, etc. The C.N. base module 146 initiates, at step 1106, the request module 148. For example, the request module 148 may begin by being initiated by the C.N. base module 146. The request module 148 connects to the system base module 120. Then the request module 148 sends a request to activate the electrochemical stack 104 to the base module 120. The request module 148 is continuously polling for a request for the data stored in the hydrogen database 150 from the activation module 122. The request module 148 receives a request for the data stored in the hydrogen database 150 from the activation module 122. Then the request module 148 sends the data stored in the hydrogen database 150 to the activation module 122. The request module 148 connects to the customer module 134. Then the request module 148 is continuously polling for a request from the customer module 134 for the data stored in the hydrogen database 150. The request module 148 receives a request for the data stored in the hydrogen database 150 from the customer module 134. The request module 148 sends the data stored in the hydrogen database 150 to the customer module 134. The request module 148 returns to the C.N. base module 146.

FIG. 12 illustrates the request module 148. The process begins with the request module 148 being initiated, at step 1200, by the C.N. base module 146. The request module 148 connects, at step 1202, to the system base module 120. Then the request module 148 sends, at step 1204, a request to activate the electrochemical stack 104 to the base module 120. For example, the request module 148 is sending a request to the base module 120 to activate the electrochemical stack 104 to produce hydrogen for the customer in order to fulfill the customer's hydrogen request. The request module 148 is continuously polling, at step 1206, for a request for the data stored in the hydrogen database 150 from the activation module 122. For example, the request module 148 is continuously polling to receive a request to send the data such as the customer's name, such as client 1, the number of electrochemical stacks the customer is currently operating, such as 10 electrochemical stacks, the hydrogen request, such as 600 kg of hydrogen, the date, and the time. The request module 148 receives, at step 1208, a request for the data stored in the hydrogen database 150 from the activation module 122. For example, the request module 148 receives a request for the data stored in the hydrogen database 150 such as the customer's name, such as client 1, the number of electrochemical stacks the customer is currently operating, such as 10 electrochemical stacks, the hydrogen request, such as 600 kg of hydrogen, the date, and the time.

Then the request module 148 sends, at step 1210, the data stored in the hydrogen database 150 to the activation module 122. For example, the request module 148 sends the data such as the customer's name, such as client 1, the number of electrochemical stacks the customer is currently operating, such as 10 electrochemical stacks, the hydrogen request, such as 600 kg of hydrogen, the date, and the time. The request module 148 connects, at step 1212, to the customer module 134. Then the request module 148 is continuously polling, at step 1214, for a request from the customer module 134 for the data stored in the hydrogen database 150. For example, the request module 148 is continuously polling to receive a request to send the data such as the customer's name, such as client 1, the number of electrochemical stacks the customer is currently operating, such as 10 electrochemical stacks, the hydrogen request, such as 600 kg of hydrogen, the date, and the time. The request module 148 receives, at step 1216, a request for the data stored in the hydrogen database 150 from the customer module 134. For example, the request module 148 receives a request for the data stored in the hydrogen database 150 such as the customer's name, such as client 1, the number of electrochemical stacks the customer is currently operating, such as 10 electrochemical stacks, the hydrogen request, such as 600 kg of hydrogen, the date, and the time. The request module 148 sends, at step 1218, the data stored in the hydrogen database 150 to the customer module 134. For example, the request module 148 sends the data such as the customer's name, such as client 1, the number of electrochemical stacks the customer is currently operating, such as 10 electrochemical stacks, the hydrogen request, such as 600 kg of hydrogen, the date, and the time. The request module 148 returns, at step 1220, to the C.N. base module 146.

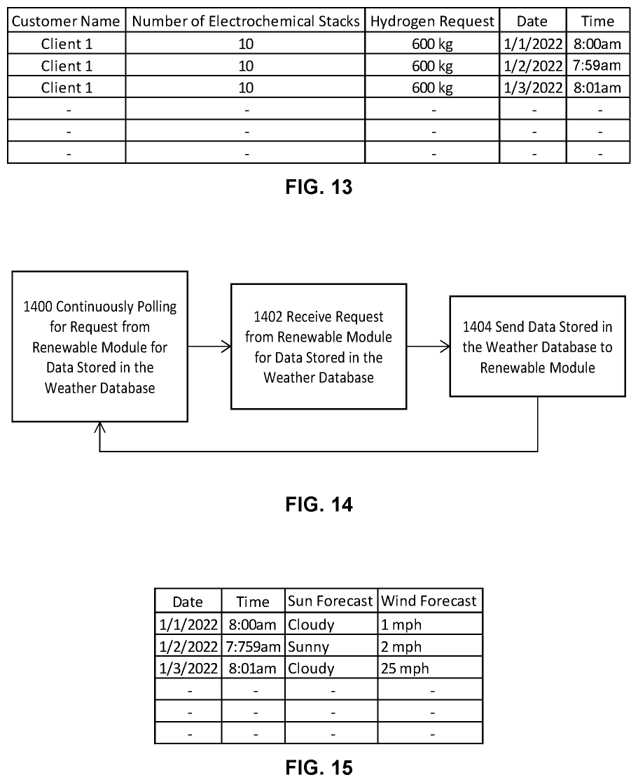

FIG. 13 illustrates the hydrogen database 150. The hydrogen database 156 contains the customer's name, such as client 1, the number of electrochemical stacks the customer is currently operating, such as 10 electrochemical stacks, the hydrogen request, such as 600 kg of hydrogen, the date, and the time. In some embodiments, the database may contain a customer ID, the customer's location, the number of active electrochemical stacks, and the number of electrochemical stacks that are not active. In some embodiments, the hydrogen request may be daily, hourly, weekly, monthly, quarterly, yearly, etc. In some embodiments, the user may not have to input the hydrogen request, such as having an automated system that may determine the hydrogen request by reading a database of the customer's orders, required shipments, etc.

FIG. 14 illustrates the weather module 156. The process begins with the weather module 156 continuously polling, at step 1400, to receive a request for the data stored in the weather database 158 from the renewable module 136. For example, the weather module 156 is continuously polling to receive a request from the renewable module 136 for the stored in the weather database 158, such as the information about the weather forecast, such as the date and time, the sun, and the wind forecast. In some embodiments, the sun forecast may use the UV index to determine the amount of sunlight for the day. In some embodiments, the wind forecast may use the peak strength of the wind during the day. The database is used to determine if the weather forecast for the day allows for the use of renewable energy such as solar panels or wind turbines. In some embodiments, the weather forecast may be updated in real-time by the weather network 156. Then the weather module 156 receives, at step 1402, a request from the renewable module 136 for the data stored in the weather database 158. For example, the weather module 156 receives a request for the weather data such as the information about the weather forecast, such as the date and time, the sun forecast, and the wind forecast. In some embodiments, the sun forecast may use the UV index to determine the amount of sunlight for the day. In some embodiments, the wind forecast may use the peak strength of the wind during the day. The database is used to determine if the weather forecast for the day allows for the use of renewable energy such as solar panels or wind turbines. In some embodiments, the weather forecast may be updated in real-time by the weather network 156. Then the weather module 156 sends, at step 1404, the data stored in the weather database 158 to the renewable module 136, and the process returns to continuously polling to receive a request from the renewable module 136. For example, the weather module 156 sends the data stored in the weather module 158, such as the information about the weather forecast, such as the date and time, the sun forecast, and the wind forecast. In some embodiments, the sun forecast may use the UV index to determine the amount of sunlight for the day. In some embodiments, the wind forecast may use the peak strength of the wind during the day. The database is used to determine if the weather forecast for the day allows for the use of renewable energy such as solar panels or wind turbines. In some embodiments, the weather forecast may be updated in real-time by the weather network 156.

FIG. 15 illustrates the weather database 158. The database contains information about the weather forecast, such as the date and time, the sun forecast, and the wind forecast. In some embodiments, the sun forecast may use the UV index to determine the amount of sunlight for the day. In some embodiments, the wind forecast may use the peak strength of the wind during the day. The database is used to determine if the weather forecast for the day allows for the use of renewable energy such as solar panels or wind turbines. In some embodiments, the weather forecast may be updated in real-time by the weather network 154.

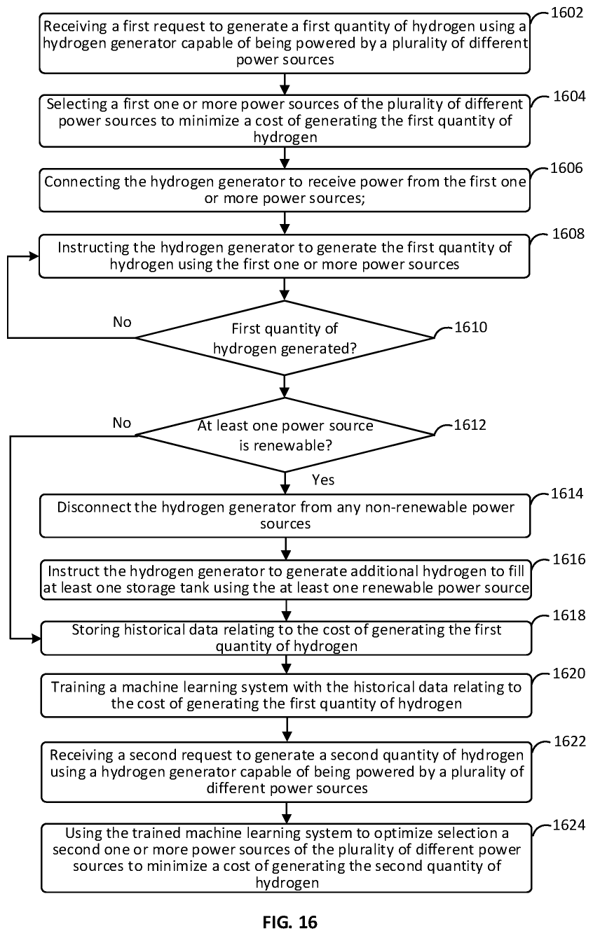

With continuing reference to FIG. 1, FIG. 16 is a flowchart of a method for optimizing hydrogen production using a hydrogen generator (e.g., system 102) capable of being powered by a plurality of different power sources 106. The method begins at step 1602 by receiving a first request to generate a first quantity of hydrogen. One embodiment of a process for creating and receiving requests is described in connection with FIGS. 7 and 12. For example, a request may include, without limitation, a customer name or other ID, a requested amount of hydrogen, a date, and a time.

At step 1604, the method continues by selecting a first one or more power sources 106 to minimize a cost of generating the first quantity of hydrogen. In one embodiment, the selection process is described in connection with FIGS. 4 and 9. However, other selection processes are possible, as described in greater detail below.

At step 1606, the method continues by connecting the hydrogen generator to receive power from the first one or more power sources. This may include sending an indication of the first one or more power sources to a controller, as described in connection step 410 of FIG. 5. Various switching mechanisms may be employed as known in the art to connect the system of FIG. 1 to the one or more power sources. At step 1608, the method continues by instructing the hydrogen generator (e.g., system 102) to generate the first quantity of hydrogen using the first one or more power sources.

At step 1610, a determination is made whether the first quantity of hydrogen has been generated. If not, the method loops back to step 1608. If the first quantity of hydrogen has been generated, the method continues, at step 1612, by determining whether at least one of the first one or more power sources is renewable, e.g., solar, wind, geothermal, or hydroelectric. If so, the method continues at step 1614 by disconnecting the hydrogen generator from any non-renewable power sources, such as the grid provided by a local energy utility, and instructing the hydrogen generator to generate additional hydrogen to fill at least one storage tank 118 using the at least one renewable power source. This allows the system 102 to take advantage of renewable power sources that are only intermittently available. For example, if there is wind, it can be utilized to generate additional hydrogen, which can subsequently used to fulfil one or more future requests.

Thereafter, or if at least one of the first one or more power sources 106 is not renewable, the method continues at step 1618 by storing historical data relating to the cost of generating the first quantity of hydrogen. The historical data may include one or more of: an indication of the first quantity; at least one of a date and time during which the first quantity of hydrogen is generated; and price data for one or more of the plurality of different power sources. The price data may include a price per unit of electricity for one or more of the different power sources. Where the price changes over a period of time, the price data may be for a particular time interval, such as a day, an hour, etc., or may be an average price over the period of time.

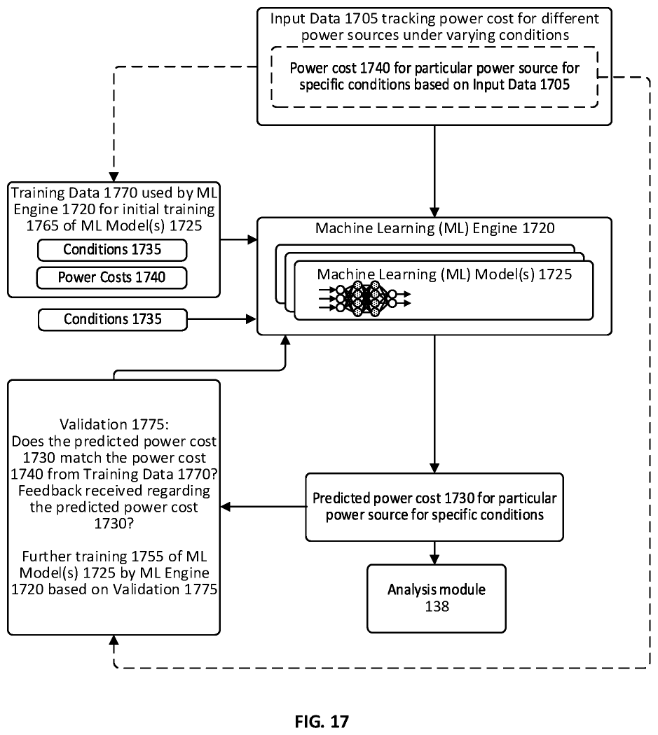

Alternatively, or in addition, the method may proceed to step 1620 by training a machine learning system with the historical data. As described in greater detail with respect to FIG. 17, the machine learning system may include a neural network. The machine learning system may also be trained with historical data produced by different hydrogen generation systems 102 with similar power sources and/or conditions.

Once the machine learning system is trained, the method may proceed with step 1622 by receiving a second request to generate a second quantity of hydrogen. At step 1624, the method may then proceed by using the trained machine learning system to optimize selection a second one or more power sources of the plurality of different power sources to minimize a cost of generating the second quantity of hydrogen.

FIG. 17 is a block diagram illustrating the use of a machine learning engine 1720 including one or more trained machine learning models 1725 to determine a predicted power cost 1730 for each of a plurality of different power sources 106 under specific conditions 1735. Once the predicted power costs 1730 are identified, one or more power sources 106 may be selected (for example, by the analysis module 138) that minimize the cost of hydrogen generation for a particular customer request and/or a specified time interval (day, hour, etc.) under current conditions. While weather is one condition that may affect the power costs, other conditions may include time-of-use pricing, surge pricing, switching costs, availability of stored hydrogen. In one embodiment, cost may be predictive in anticipating demands and taking advantage of producing and storing during low-cost periods such as night to support anticipated demand. Additionally, the machine learning could monitor conditions such as, without limitation, expected downtime due to machine repairs or component failures both in electrolyzer and supplied power (e.g., if turbine needs service every 10 years, system could anticipate the cycle time for this maintenance).

The ML engine 1720 and/or the ML model(s) 1725 can include one or more neural network (NNs), one or more convolutional neural networks (CNNs), one or more trained time delay neural networks (TDNNs), one or more deep networks, one or more autoencoders, one or more deep belief nets (DBNs), one or more recurrent neural networks (RNNs), one or more generative adversarial networks (GANs), one or more conditional generative adversarial networks (cGANs), one or more other types of neural networks, one or more trained support vector machines (SVMs), one or more trained random forests (RFs), one or more computer vision systems, one or more deep learning systems, one or more classifiers, one or more transformers, or combinations thereof. Within FIG. 17, a graphic representing the trained ML model(s) 1725 illustrates a set of circles connected to another. Each of the circles can represent a node, a neuron, a perceptron, a layer, a portion thereof, or a combination thereof. The circles are arranged in columns. The leftmost column of white circles represent an input layer. The rightmost column of white circles represent an output layer. Two columns of shaded circled between the leftmost column of white circles and the rightmost column of white circles each represent hidden layers.

In one embodiment, input data 1705 for the ML model(s) 1725 may be obtained from the historical database of FIG. 5, historical energy database of FIG. 10, the weather database shown of FIG. 15, pricing rules associated with use of the power sources 106 (e.g., rules regarding time-of-use pricing, surge pricing, switching costs, etc.). For example, the input data 1705 may include dates, times, amounts of hydrogen requested, amounts of hydrogen generated, amount of hydrogen stored, power sources used to generate the hydrogen (e.g., solar, wind, or grid), wind energy unit costs (e.g., watts per hour), solar energy unit costs, grid energy unit costs, weather forecasts, e.g., sun forecasts (and/or observed data regarding UV and cloud cover conditions), and/or a wind forecasts (and/or observed data regarding wind speed). The input data 1705 includes numerous examples of power costs 1740 for particular power sources 106 under specific conditions 1735.

Before using the one or more ML models 1725 to determine a predicted power cost 1730 for each of the power sources 106, the ML engine 1720 performs initial training 1765 of the one or more ML models 1725 using training data 1770. The training data 1770 can include examples of input data tracking power costs 1740 over time (e.g., as in the input data 1705) under varying conditions 1735. The training data 1770 may be previously obtained from operation of the hydrogen generation system 102 and/or from other hydrogen generation systems 102 with similar power sources 106.

In the initial training 1765, the ML engine 1720 can form connections and/or weights based on the training data 1770 between nodes of a neural network or another form of neural network. For instance, the ML engine 1720 can form connections and/or weights associating power costs 1740 with various conditions 1730 for particular power sources 106. In the initial training 1765, the ML engine 1720 can be trained to output the power cost 1740 in the training data 1770 in response to receipt of the corresponding input data in the training data 1770. In particular, the ML engine 1720 can be trained to output a predicted power cost 1730 for a particular power source 106 in response to inputting one or more conditions 1735.

During a validation 1775 of the initial training 1765 (and/or further training 1755), the input data 1705 is input into the one or more ML models 1725 to identify the predicted power cost 1730 as described above. The ML engine 1720 performs validation 575 at least in part by determining whether the predicted power cost 1730 matches the power cost 1740 from the training data 1770. If the predicted power cost 1730 matches the power cost 1740 during validation 1775, then the ML engine 1720 performs further training 1755 of the one or more ML models 1725 by updating the one or more ML models 1725 to reinforce weights and/or connections within the one or more ML models 1725 that contributed to the identification of the power cost 530, encouraging the one or more ML models 1725 to make similar power cost determinations given similar inputs. If the predicted power cost 1730 does not match the power cost 1740 during validation 1775, then the ML engine 1720 performs further training 1755 of the one or more ML models 1725 by updating the one or more ML models 1725 to weaken, remove, and/or replace weights and/or connections within the one or more ML models that contributed to the identification of the predicted power cost 1730, discouraging the one or more ML models 1725 from making similar power cost determinations given similar inputs.

Validation 1775 and further training 1755 of the one or more ML models 1725 can continue after the one or more ML models 1725 is being used to identify predicted power costs 1730 in response to current conditions 1735. This may be accomplished through feedback 1750.

In some examples, the feedback 1750 can be received from a user via a user interface, for instance via an input from the user interface that approves or declines use of the predicted power cost. If the feedback 1750 is positive (e.g., expresses, indicates, and/or suggests approval of the predicted power cost 1730, success of the predicted power cost 1730, and/or accuracy the predicted power cost 1730), then the ML engine 1720 performs further training 1755 of the one or more ML models 1725 by updating the one or more ML models 1725 to reinforce weights and/or connections within the one or more ML models 1725 that contributed to the identification of the predicted power cost 1730, encouraging the one or more ML models 1725 to make similar power cost determinations given similar inputs. If the feedback 1750 is negative (e.g., expresses, indicates, and/or suggests disapproval of the predicted power cost 1730, failure of the predicted power cost 1730, and/or inaccuracy of the predicted power cost 1730) then the ML engine 1720 performs further training 1755 of the one or more ML models 1725 by updating the one or more ML models 1725 to weaken, remove, and/or replace weights and/or connections within the one or more ML models that contributed to the identification of the predicted power cost 1730, discouraging the one or more ML models 1725 to make similar power cost determinations given similar inputs.

Once the one or more ML models 1725 identify a predicted power cost 1730 for particular conditions 1735 for each of the available power sources 106, the predicted power costs 1730 may be provided, for example, to the analysis module 138 for selection of one or more power sources 106 to power the hydrogen generation system 102. The analysis module 138 may further take into account various additional factors, such as time-of-use rates, surge pricing, switching costs, etc., in determining whether to switch power sources 106 and/or which power sources 106 to select based on the predicted power costs 1730.

Numerous examples are provided herein to enhance understanding of the present disclosure. A specific set of statements is provided as follows.
Statement 1. A system for generating hydrogen comprises: one or more processors operatively connected a hydrogen generator capable of being powered by a plurality of different power sources; and a non-transitory computer-readable medium storing instructions that, when executed by the one or more processors, cause the one or more processors to: receive a first request to generate a first quantity of hydrogen; select a first one or more power sources of the plurality of different power sources to minimize a cost of generating the first quantity of hydrogen; connect the hydrogen generator to receive power from the first one or more power sources; and instruct the hydrogen generator to generate the first quantity of hydrogen using the first one or more power sources.
Statement 2. The system of statement 1, wherein the first one or more power sources includes at least one renewable power source, and wherein the instructions further cause the one or more processors to: disconnect the hydrogen generator from any non-renewable power sources; and instruct the hydrogen generator to generate additional hydrogen to fill at least one storage tank using the at least one renewable power source.
Statement 3. The system of statements 1-2, wherein the at least one renewable power source is selected from the group consisting of solar, wind, geothermal, and hydropower.
Statement 4. The system of statement 1-3, wherein the instructions further cause the one or more processors to store historical data relating to the cost of generating the first quantity of hydrogen.
Statement 5. The system of statements 1-4, wherein the historical data includes an indication of the first quantity.
Statement 6. The system of statements 1-5, wherein the historical data includes one or more of a date and time during which the first quantity of hydrogen is generated.
Statement 7. The system of statements 1-6, wherein the historical data includes price data for one or more of the plurality of different power sources.
Statement 8. The system of statements 1-7, wherein the historical data includes weather data for a period of time during which the first quantity of hydrogen is generated.
Statement 9. The system of statements 1-8, wherein the weather data is selected from the group consisting of a UV index, a level of cloud cover, and a wind speed.
Statement 10. The system of statements 1-9, wherein to store the historical data relating to the cost of generating the first quantity of hydrogen includes training a machine learning system with the historical data.
Statement 11. The system of statements 1-10, wherein the machine learning system includes a neural network.
Statement 12. The system of statements 1-11, wherein the instructions further cause the one or more processors to: receive a second request to generate a second quantity of hydrogen; and use the trained machine learning system to optimize selection a second one or more power sources of the plurality of different power sources to minimize a cost of generating the second quantity of hydrogen.
Statement 13. The system of statement 1-12, wherein to use the trained machine learning system includes providing as input to the machine learning system at least one of an indication of the second quantity, price data for one or more of the plurality of different power sources, one or more of a date and time of the second request, and a weather forecast.
Statement 14. A computer-implemented method for generating hydrogen comprising: receiving a first request to generate a first quantity of hydrogen using a hydrogen generator capable of being powered by a plurality of different power sources; selecting a first one or more power sources of the plurality of different power sources to minimize a cost of generating the first quantity of hydrogen; connecting the hydrogen generator to receive power from the first one or more power sources; and instructing the hydrogen generator to generate the first quantity of hydrogen using the first one or more power sources.
Statement 15. The computer-implemented method of statement 14, wherein the first one or more power sources includes at least one renewable power source, the computer-implemented method further comprising: disconnecting the hydrogen generator from any non-renewable power sources; and instructing the hydrogen generator to generate additional hydrogen to fill at least one storage tank using the at least one renewable power source.
Statement 16. The computer-implemented method of statements 14-15, wherein the at least one renewable power source is selected from the group consisting of solar, wind, geothermal, and hydropower.
Statement 17. The computer-implemented method of statements 14-16, further comprising storing historical data relating to the cost of generating the first quantity of hydrogen.
Statement 18. The computer-implemented method of statements 14-17, wherein the historical data includes one or more of: an indication of the first quantity; at least one of a date and time during which the first quantity of hydrogen is generated; and price data for one or more of the plurality of different power sources.
Statement 19. The computer-implemented method of statements 14-18, wherein the historical data includes weather data for a period of time during which the first quantity of hydrogen is generated, wherein the weather data is selected from the group consisting of a UV index, a level of cloud cover, and a wind speed.
Statement 20. The computer-implemented method of statements 14-19, wherein storing the historical data relating to the cost of generating the first quantity of hydrogen includes training a machine learning system with the historical data.
Statement 21. The computer-implemented method of statements 14-20, wherein the machine learning system includes a neural network.
Statement 22. The computer-implemented method of statements 14-21, further comprising: receiving a second request to generate a second quantity of hydrogen; and using the trained machine learning system to optimize selection a second one or more power sources of the plurality of different power sources to minimize a cost of generating the second quantity of hydrogen.
Statement 23. The computer-implemented method of statements 14-22, wherein using the trained machine learning system includes providing as input to the machine learning system at least one of an indication of the second quantity, price data for one or more of the plurality of different power sources, one or more of a date and time of the second request, and a weather forecast.
Statement 24. A non-transitory computer-readable medium storing program code that, when executed by one or more processors, causes the one or more processors to perform a method for generating hydrogen comprising: receiving a first request to generate a first quantity of hydrogen using a hydrogen generator capable of being powered by a plurality of different power sources; selecting a first one or more power sources of the plurality of different power sources to minimize a cost of generating the first quantity of hydrogen; connecting the hydrogen generator to receive power from the first one or more power sources; and instructing the hydrogen generator to generate the first quantity of hydrogen using the first one or more power sources.

Embodiments of the present disclosure may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a FLASH memory, a flexible disk, a hard disk, any other magnetic medium, any other optical medium, RAM, PROM, EPROM, a FLASHEPROM, and any other memory chip or cartridge.

Aspects of the present disclosure are set forth in the following description and related figures directed to specific embodiments. Those of skill in the art will recognize that alternate embodiments may be devised without departing from the scope of the appended claims. Additionally, well-known elements will not be described in detail or will be omitted so as not to obscure more relevant details.

As used herein, the word exemplary means serving as an example, instance, or illustration. The embodiments described herein are not limiting but rather are exemplary only. The described embodiments are not necessarily to be construed as preferred or advantageous over other embodiments. Moreover, the terms “embodiments of the invention,” “embodiments,” or “invention” do not require that all embodiments include the discussed feature, advantage, or mode of operation.

Further, many of the embodiments described herein are described in sequences of actions to be performed by, for example, elements of a computing device. Those skilled in the art will recognize that specific circuits can perform the various sequence of actions described herein (e.g., application-specific integrated circuits or “ASICs”) and/or by program instructions executed by at least one processor. Additionally, the sequence of actions described herein can be embodied entirely within any form of non-transitory computer-readable storage medium. The execution of the sequence of actions enables the processor to perform the functionality described herein. Thus, the various aspects of the present disclosure may be embodied in several different forms, all of which have been contemplated to be within the scope of the claimed subject matter. In addition, for each of the embodiments described herein, the corresponding form of any such embodiments may be described herein as, for example, a computer configured to perform the described action.

When listing various aspects of the products, methods, or system described herein, any feature, element, or limitation of one aspect, example, or claim may be combined with any other feature, element, or limitation of any other aspect when feasible (i.e., not contradictory).

As used herein, the singular forms “a,” “an,” and “the” include plural references unless the context clearly dictates otherwise. Although any systems and methods similar or equivalent to those described herein can be used to practice or test embodiments, only some exemplary systems and methods are now described. It should be understood that the embodiments are intended to be open-ended in that an item or items used in the embodiments is not meant to be an exhaustive listing of such items or items or meant to be limited to only the listed item or items.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

The foregoing detailed description of the technology herein has been presented for purposes of illustration and description. It is not intended to be exhaustive or to limit the technology to the precise form disclosed. Many modifications and variations are possible in light of the above teachings. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims.

What is claimed is:

1. A system for generating hydrogen comprising:
one or more processors operatively connected a hydrogen generator capable of being powered by a plurality of different power sources; and
a non-transitory computer-readable medium storing instructions that, when executed by the one or more processors, cause the one or more processors to:
receive a first request to generate a first quantity of hydrogen;
select a first one or more power sources of the plurality of different power sources to minimize a cost of generating the first quantity of hydrogen;
connect the hydrogen generator to receive power from the first one or more power sources; and
instruct the hydrogen generator to generate the first quantity of hydrogen using the first one or more power sources.

2. The system of claim 1, wherein the first one or more power sources includes at least one renewable power source, and wherein the instructions further cause the one or more processors to:
disconnect the hydrogen generator from any non-renewable power sources; and
instruct the hydrogen generator to generate additional hydrogen to fill at least one storage tank using the at least one renewable power source.

3. The system of claim 2, wherein the at least one renewable power source is selected from the group consisting of solar, wind, geothermal, and hydropower.

4. The system of claim 1, wherein the instructions further cause the one or more processors to store historical data relating to the cost of generating the first quantity of hydrogen.

5. The system of claim 4, wherein the historical data includes an indication of the first quantity.

6. The system of claim 4, wherein the historical data includes one or more of a date and time during which the first quantity of hydrogen is generated.

7. The system of claim 4, wherein the historical data includes price data for one or more of the plurality of different power sources.

8. The system of claim 4, wherein the historical data includes weather data for a period of time during which the first quantity of hydrogen is generated.

9. The system of claim 8, wherein the weather data is selected from the group consisting of a UV index, a level of cloud cover, and a wind speed.

10. The system of claim 4, wherein to store the historical data relating to the cost of generating the first quantity of hydrogen includes training a machine learning system with the historical data.

11. The system of claim 10, wherein the machine learning system includes a neural network.

12. The system of claim 10, wherein the instructions further cause the one or more processors to:
receive a second request to generate a second quantity of hydrogen; and
use the trained machine learning system to optimize selection a second one or more power sources of the plurality of different power sources to minimize a cost of generating the second quantity of hydrogen.

13. The system of claim 12, wherein to use the trained machine learning system includes providing as input to the machine learning system at least one of an indication of the second quantity, price data for one or more of the plurality of different power sources, one or more of a date and time of the second request, and a weather forecast.

14. A computer-implemented method for generating hydrogen comprising:
receiving a first request to generate a first quantity of hydrogen using a hydrogen generator capable of being powered by a plurality of different power sources;
selecting a first one or more power sources of the plurality of different power sources to minimize a cost of generating the first quantity of hydrogen;
connecting the hydrogen generator to receive power from the first one or more power sources; and
instructing the hydrogen generator to generate the first quantity of hydrogen using the first one or more power sources.

15. The computer-implemented method of claim 14, wherein the first one or more power sources includes at least one renewable power source, the computer-implemented method further comprising:
disconnecting the hydrogen generator from any non-renewable power sources; and
instructing the hydrogen generator to generate additional hydrogen to fill at least one storage tank using the at least one renewable power source.

16. The computer-implemented method of claim 15, wherein the at least one renewable power source is selected from the group consisting of solar, wind, geothermal, and hydropower.

17. The computer-implemented method of claim 14, further comprising storing historical data relating to the cost of generating the first quantity of hydrogen.

18. The computer-implemented method of claim 17, wherein the historical data includes one or more of:
an indication of the first quantity;
at least one of a date and time during which the first quantity of hydrogen is generated; and
price data for one or more of the plurality of different power sources.

19. The computer-implemented method of claim 17, wherein the historical data includes weather data for a period of time during which the first quantity of hydrogen is generated, wherein the weather data is selected from the group consisting of a UV index, a level of cloud cover, and a wind speed.

20. The computer-implemented method of claim 17, wherein storing the historical data relating to the cost of generating the first quantity of hydrogen includes training a machine learning system with the historical data.

21. The computer-implemented method of claim 20, wherein the machine learning system includes a neural network.

22. The computer-implemented method of claim 20, further comprising:
receiving a second request to generate a second quantity of hydrogen; and
using the trained machine learning system to optimize selection a second one or more power sources of the plurality of different power sources to minimize a cost of generating the second quantity of hydrogen.

23. The computer-implemented method of claim 22, wherein using the trained machine learning system includes providing as input to the machine learning system at least one of an indication of the second quantity, price data for one or more of the plurality of different power sources, one or more of a date and time of the second request, and a weather forecast.

24. A non-transitory computer-readable medium storing program code that, when executed by one or more processors, causes the one or more processors to perform a method for generating hydrogen comprising:
receiving a first request to generate a first quantity of hydrogen using a hydrogen generator capable of being powered by a plurality of different power sources;
selecting a first one or more power sources of the plurality of different power sources to minimize a cost of generating the first quantity of hydrogen;
connecting the hydrogen generator to receive power from the first one or more power sources; and
instructing the hydrogen generator to generate the first quantity of hydrogen using the first one or more power sources.
